(19) United States
(12) Patent Application Publication
(10) Pub. No.: US 2011/0292703 A1
(43) Pub. Date: Dec. 1, 2011

(54) Single-stage AC-to-DC converter with isolation and power factor correction

(75) Inventor: Slobodan Cuk, Laguna Niguel, CA (US)

(73) Assignee: CUKS, LLC

(21) Appl. No.: 12/802,122

(22) Filed: May 29, 2010

(51) Int. Cl. H02M 7/06

(52) U.S. Cl. 363/126

(57) ABSTRACT

A new class of Single-Stage AC-DC converters with built-in Isolation and PFC feature is introduced along with the companion hybrid switching conversion method. Several different converter topologies are introduced, which all feature three switches only, single magnetic component and low voltage stresses on all switches.

### FIELD OF INVENTION

This invention relates to the field of AC-DC conversion, which can provide the galvanic isolation and Power Factor Correction performance features. The present solutions can provide these functions but to do so they use predominantly three power processing stages, which result in low efficiency, big size and weight and high cost. The alternative present solutions employing two power-processing stages result even in lower efficiency and bigger size.

The present invention opens up a new class of single-stage AC-DC converters, which provide both galvanic isolation and Power Factor Correction features by processing the AC input power to DC output power in a single power processing stage, thus resulting in much improved efficiency reduced size and weight and lower cost. The new class of single-stage AC-DC converters was made possible by heretofore not available hybrid switching method for step-up conversion, which in turns results in a number of distinct switching converter topologies.

The prior art AC-DC converters using three stage or two stage processing are characterized by each power processing stage consisting of even number of switches, such as 4 for diode bridge, two for PFC converter and at least four for Isolated DC-DC converters. The even number of switches is postulated by the present PWM square-wave switching technology, which explicitly forbids the existence of the converters with odd number of switches, such as 3, 5, etc. In a clear departure from the present classification, the new single-stage AC-DC converters introduced here all have a distinguishing characteristic of having a total of three switches as opposed to total of 10 or more switches in three-stage AC-DC converters.

### OBJECTIVES

The objective of this invention is to replace the existing three-stage AC-DC converters with a single-stage AC-DC converter solution providing both galvanic isolation and Power Factor Correction features.

The prior-art simple AC-DC converter comprising of only full bridge rectifier followed by the large capacitor is not allowed as a single-stage solution due to injection of the high frequency harmonics into utility line. Hence, some form of active control and reduction of harmonics is required in order to meet stringent requirements of IEC-1000-3-2.

The prior-art solutions which provide the PFC function and isolation do so by use of the multiple power conversion stages connected in series (typically three), thus degrading efficiency and increasing cost and size. To realize PFC and isolation features, the prior art sue as a first stage full bridge rectifier, a separate non-isolated switching DC-DC converter to provide the PFC function and low total harmonic distortion of the input AC current. Since the present DC-DC converters used for PFC (for example, the non-isolated boost converter) have no isolation, the third DC-DC converter power processing stage with isolation transformer is needed (for example, phase-shifted full-bridge converter for high power or forward converter for medium to low power). It is clear that the present AC-to-DC solutions then require three cascaded converters (bridge rectifier followed by two DC/DC converters) so that total power is processed three times resulting in low overall efficiency and high power losses. Until this invention, it was considered impossible to have a Direct AC-DC converter with PFC and isolation features provided in a single power processing stage and without full-bridge rectifier. The present invention dispels that widely held belief by providing a single-stage AC-to-DC switching converter with built-in (inherent) PFC and isolation features, so that the present inefficient and costly three-stage power processing solutions could be replaced.

### DEFINITIONS AND CLASSIFICATIONS

The following notation is consistently used throughout this text in order to facilitate easier delineation between various quantities:
1. DC—Shorthand notation historically referring to Direct Current but by now has acquired wider meaning and refers generically to circuits with DC quantities;
2. AC—Shorthand notation historically referring to Alternating Current but by now has acquired wider meaning and refers to all Alternating electrical quantities (current and voltage);
3. i₁, v₂—The instantaneous time domain quantities are marked with lower case letters, such as i₁ and v₂ for current and voltage;
4. I₁, V₂—The DC components of the instantaneous periodic time domain quantities are designated with corresponding capital letters, such as I₁ and V₂;
5. Δvᵣ—The AC ripple voltage on resonant capacitor Cᵣ ;
6. f_{S}—Switching frequency of converter;
7. T_{S}—Switching period of converter inversely proportional to switching frequency f_{S};
8. T_{ON}—ON-time interval T_{ON}=DT_{S} during which switch S is turned ON;
9. T_{OFF}—OFF-time interval T_{OFF}=(1−D)T_{S} during which switch S is turned OFF;
10. D—Duty ratio of the main controlling switch S;
11. D′—Complementary duty ratio D′=1−D of the main controlling switch S;
12. fᵣ—Resonant frequency defined by resonant inductor Lᵣ and resonant capacitor Cᵣ ;
13. Tᵣ—Resonant period defined as Tᵣ=1/fᵣ;
14. S—Controllable switch with two switch states: ON and OFF and defined to operate in first and third quadrants only;
15. CR₁—Two-terminal Current Rectifier whose ON and OFF states depend on S switch states and resonant period Tᵣ;
16. CR₂—Two-terminal Current Rectifier whose ON and OFF states depend on S switch states and resonant period Tᵣ;

### BRIEF DESCRIPTION OF THE DRAWINGS

FIG. 1a illustrates the first embodiment of the present invention; FIG. 1b illustrates the state of the controllable switch S and FIG. 1c illustrates the Unity Power Factor operation when operated directly from the AC line.

FIG. 2a illustrates the second embodiment of the present invention. FIG. 2b illustrates the state of the controllable switch S and FIG. 2c illustrates the Unity Power Factor operation when operated directly from the AC line.

FIG. 3a illustrates the third embodiment of the present invention. FIG. 3b illustrates the state of the controllable switch S and FIG. 3c illustrates the Unity Power Factor operation when operated directly from the AC line.

FIG. 4a-g is a quadrant definition of various semiconductor switch implementations

FIG. 5a illustrates the prior-art AC-DC converter with full-bridge rectifier and large capacitor, and FIG. 5b illustrates the bad Power Factor of the AC-DC converter in FIG. 5a.

FIG. 6a shows the schematic of prior-art isolated PFC converter with three-stage power processing, and FIG. 6b shows how the rectified AC line current is made to be proportional and in phase with rectified AC line voltage when PFC control is implemented.

FIG. 7a shows one specific implementation of the three power processing stages of FIG. 6a and

FIG. 7b shows how the rectified AC line current is made to be proportional and in phase with rectified AC line voltage when PFC control is implemented with high frequency ripple current superimposed to the average line frequency current.

FIG. 8a illustrates the prior-art dual boost converter used to implement the non-isolated PFC converter in FIG. 6a.

FIG. 8a illustrates another implementation of the three-stage approach with prior-art boost converter for PFC correction and prior-art isolated full-bridge for isolated DC-DC converter.

FIG. 9a shows the schematic of prior-art isolated PFC converter with two-stage power processing, and FIG. 6b shows the specific implementation using full-bridge boost converter to generate galvanic isolation and PFC function

FIG. 10a is a block diagram of the prior-art PFC control circuit used for the PFC control of the converters in FIG. 1a and FIG. 2b with additional current folding and voltage-folding signal processing circuits and FIG. 10b is a line current.

FIG. 11a is a non-isolated version of the converter in FIG. 1a, FIG. 11b is definition of states of switch S an FIG. 11c is an extension with an energy recovery network to reduce spikes due to switching transition on resonant inductor L_{T}.

FIG. 12a is a non-isolated and polarity inverting version of the converter in FIG. 1a, FIG. 12b is definition of states of switch S an FIG. 12c is an extension with an energy recovery network to reduce spikes due to switching transitions on resonant inductor L_{T}.

FIG. 13a illustrates operation from positive polarity input voltage of the converter in FIG. 1a, FIG. 13b is definition of states of switches, FIG. 13c is a circuit model for ON-time interval and

FIG. 13d is a circuit model for OFF-time interval.

FIG. 14a is a voltage on inductor L and FIG. 14b is the current of inductor L.

FIG. 15a is a resonant circuit during ON-time interval; FIG. 15b is the resonant capacitor voltage and FIG. 15c is the corresponding resonant inductor current.

FIG. 16a is a circuit model for OFF-time interval; FIG. 16b is the resonant inductor current during the OFF time interval and FIG. 16c is the resonant capacitor voltage during OFF-time interval.

FIG. 17a displays resonant inductor current over the entire switching period and FIG. 17b displays the resonant capacitor voltage over the entire switching period.

FIG. 18a illustrates operation from negative polarity of input voltage of the converter in FIG. 1a,

FIG. 18b is definition of states of switches, FIG. 18c is a circuit model for ON-time interval and

FIG. 18d is a circuit model for OFF-time interval.

FIG. 19a is a voltage on inductor L and FIG. 19b is the current of inductor L.

FIG. 20a is a resonant circuit during ON-time interval; FIG. 20b is an simplified equivalent resonant circuit; FIG. 20c is the resonant capacitor voltage and FIG. 20d is the corresponding resonant inductor current.

FIG. 21a is a circuit model for OFF-time interval; FIG. 21b is the resonant inductor current during the OFF-time interval and FIG. 21c is the resonant capacitor voltage during OFF-time interval.

FIG. 22a displays resonant inductor current over the entire switching period and FIG. 22b displays the resonant capacitor voltage over the entire switching period.

FIG. 23a-c illustrates the variable duty ratio, constant switching frequency control.

FIG. 24a-c illustrates the constant ON-time, variable OFF-time control and hence variable switching frequency control.

FIG. 25a is used to define the requirements imposed on switch S implementation as a two-quadrant switch with characteristics shown in FIG. 25b

FIG. 27a shows the implementation of switch S with two RGIGBT devices connected in parallel.

FIG. 28a shows the embodiment with negative output DC voltage.

FIG. 28b shows the embodiment with two outputs: positive and negative output DC voltage.

FIG. 29a shows the embodiment with common input inductor and common controllable switch which generates two output DC voltages, one positive and the other negative DC voltage.

FIG. 30a shows the converter with positive DC input voltage and two DC output voltages: positive and negative. FIG. 30b shows the implementation with three converters operated from a three-phase line into a common load.

FIG. 31a shows the non-isolated PFC converter applications in data centers with intermediate hold up capacitor C_{H} for storage at 400V DC and a separate isolated DC-DC converter and FIG. 31b shows another lower voltage hold-up of 240V DC for 110V AC line only.

FIG. 32a shows the isolated converter extension as in FIG. 1a and highlights the low voltage stress of the primary side switch S (FIG. 32b) and the low voltage stresses of the output rectifiers (FIG. 32c) which are equal to output DC voltage.

FIG. 33a-c shows the step-by-step procedure of how to introduce the isolation transformer into the non-isolated converter of FIG. 13a to result in the converter of FIG. 1a for positive input voltage with transorb omitted for simplicity.

FIG. 34a-c shows the salient waveforms of the converter in FIG. 33c and FIG. 34d shows the equivalent resonant circuit model.

FIG. 35a-c shows the step-by-step procedure of how to introduce the isolation transformer into the non-isolated converter of FIG. 18a to result in the converter of FIG. 1a for negative input voltage operation with transorb omitted for simplicity.

FIG. 36a-c shows the salient waveforms of the converter in FIG. 35c and FIG. 36d shows the equivalent resonant circuit model.

FIG. 37a-c shows the scaling of the output voltage by use of the isolation transformer turns ratio for three most common applications: 48V for telecommunications, 12V for personal computers for data centers and 200V for battery charging for hybrid and electric cars and electric bicycles.

FIG. 38a shows the voltage step-up conversion to intermediate 400V DC line for the converter of FIG. 31a and FIG. 38b shows the direct step-down conversion to the output DC voltage without the intermediate high DC voltage for the converters of FIG. 1a, FIG. 2a and FIG. 1a.

FIG. 39a shows the voltage the identical voltage waveforms on inductor L and transformer T of the converter in FIG. 1a, FIG. 39b shows the integration of the transformer and inductor onto the common core to result in Integrated Magnetics structure and FIG. 39c shows the resulting zero input ripple current.

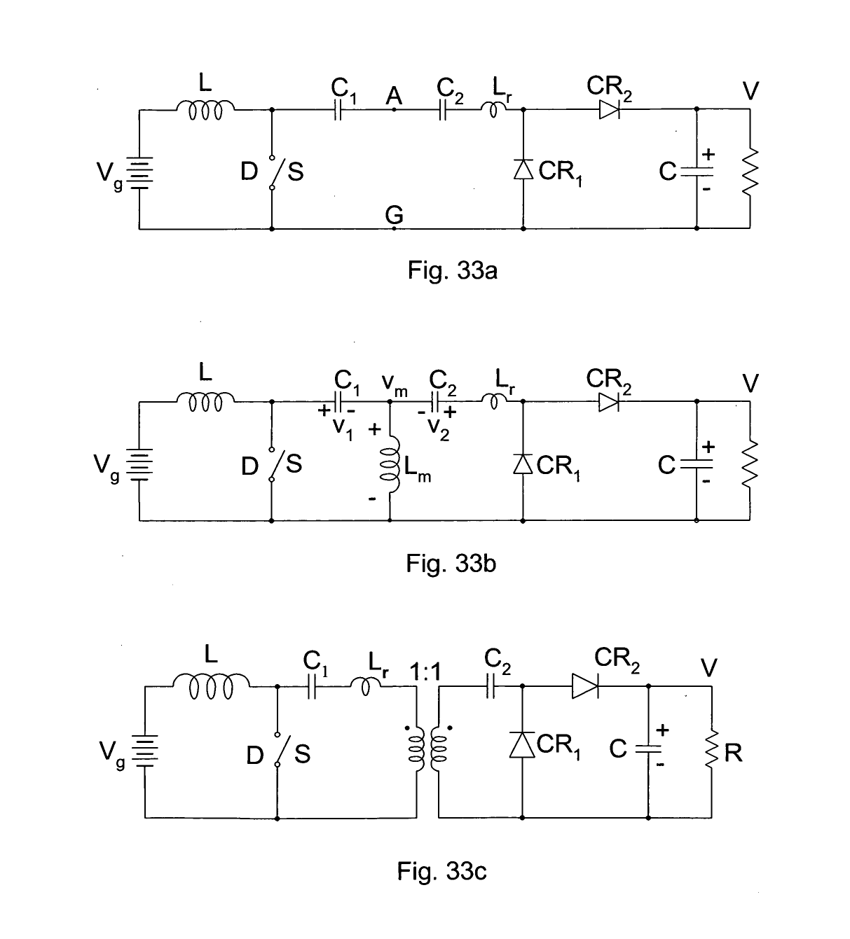

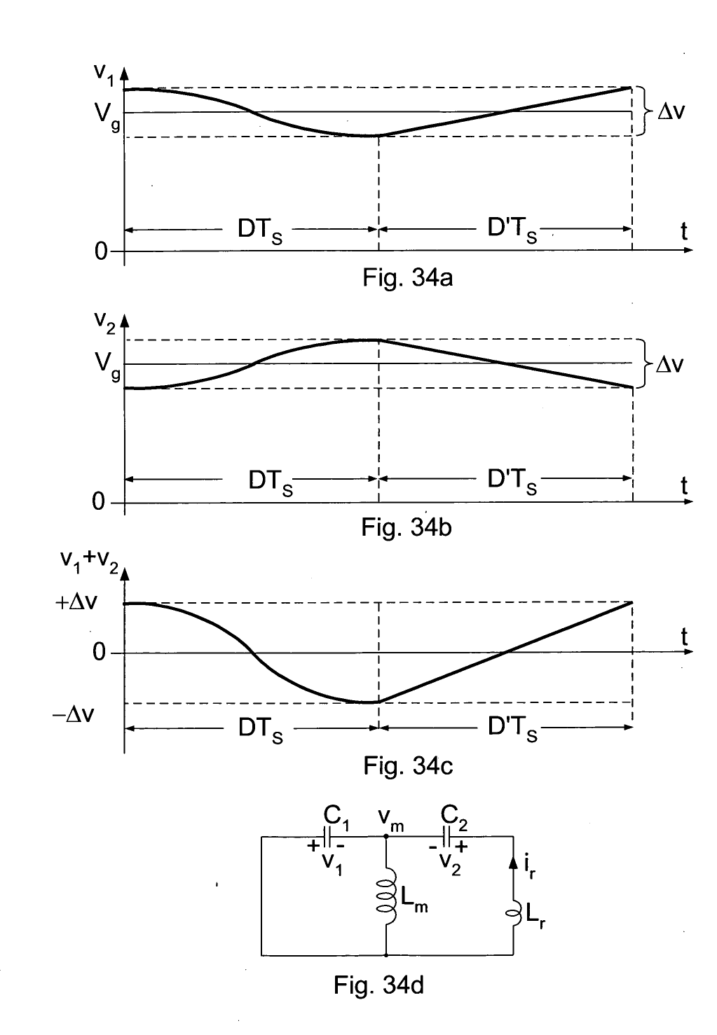

FIG. 34a-c shows the salient waveforms of the converter in FIG. 33c and FIG. 34d shows the equivalent resonant circuit model.

FIG. 40a-c show the modulation of the resonant capacitor current waveform by use of the duty ratio modulation with constant OFF-time interval.

FIG. 41 shows the ideal DC conversion gain of the converter (dotted lines) to follow equation (4) while the actual measured DC gain characteristics follows the heavy line so that the shaded area at low duty ratio indicate the soft start-up from zero output-DC voltage, which is not possible in conventional boost converters.

FIG. 42a shows the efficiency measurements obtained on an experimental prototype for wide input voltage range from 85V AC to 240V AC and FIG. 42b shows the corresponding loss measurements.

FIG. 43a displays the input voltage and input current measured on the experimental prototype for 110V AC input voltage and FIG. 43a displays the same waveforms for the 220V AC line voltage.

FIG. 44a is a table of the harmonic currents measured and THD measured on experimental 300 W prototype for 60Hz AC line and FIG. 44b is a table of the harmonic currents measured and THD measured on experimental 300 W prototype for both 60 Hz and 50 Hz AC lines.

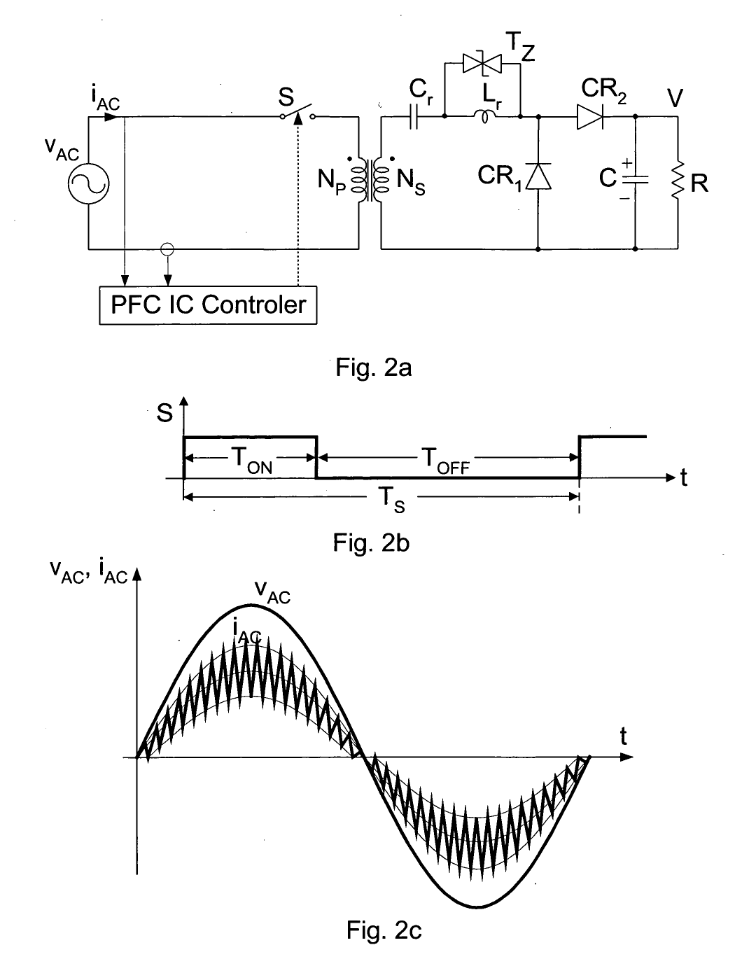

FIG. 45a is a non-isolated extension of the converter in FIG. 2a, FIG. 45b shows the states of the switch S and FIG. 45c is the isolated extension of the converter in FIG. 45a with the energy recovery network included.

FIG. 45a is a non-isolated extension of the converter in FIG. 2a, FIG. 45b shows the states of the switch S and FIG. 45c is the isolated extension of the converter in FIG. 45a with the energy recovery network included.

### SUMMARY OF INVENTION

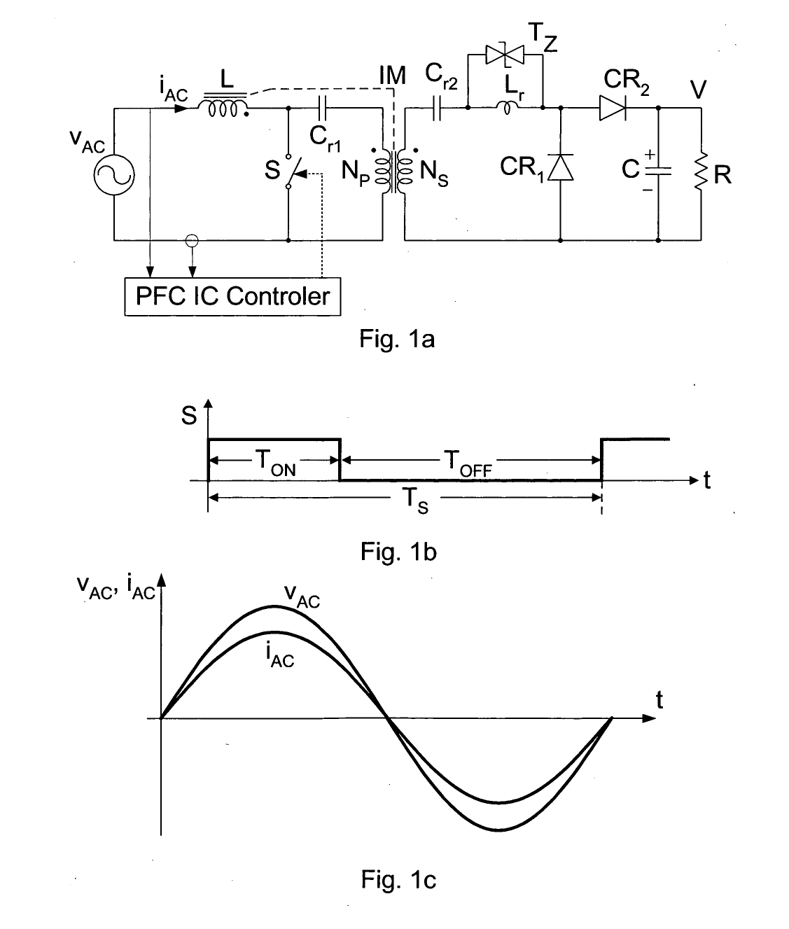

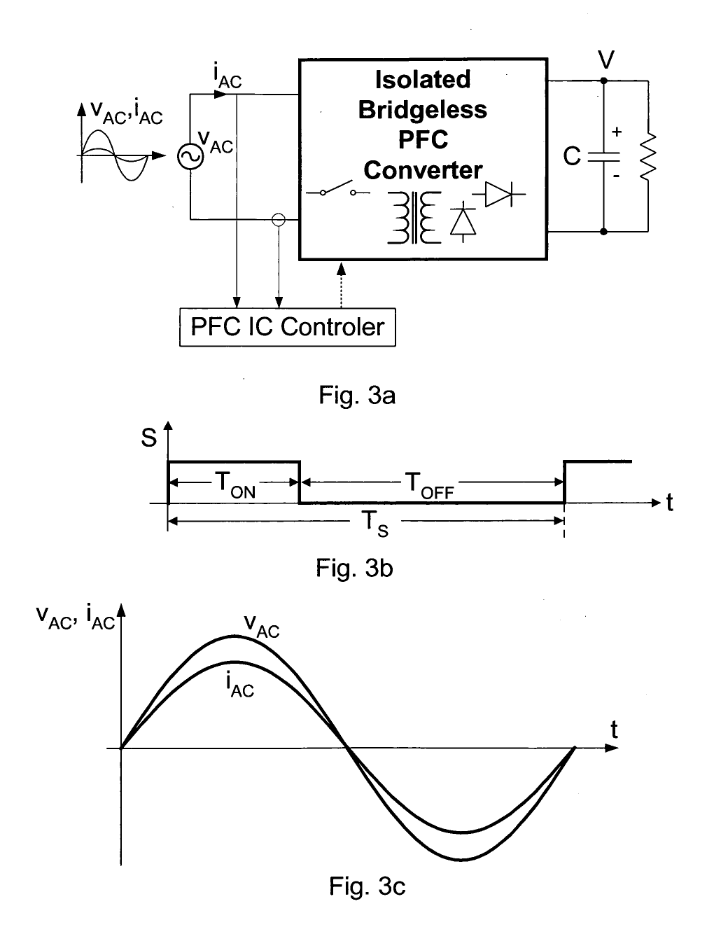

The present invention of single stage-AC-DC converters with isolation and Power Factor Correction can be divided into three key categories:
1. A converter topology with continuous input current illustrated in FIG. 1a.
2. A converter topology with pulsating input current illustrated in FIG. 2a.
3. A general method based on one active controllable switch S and two diode switches. As illustrated in FIG. 3a.
   Those skilled in the art, could follow the general method described in relation to FIG. 3a to devise other alternative converter topologies to those in 1. and 2. above which provide the same benefits. Each of the three alternatives are now introduced and their fundamental operation briefly summarized below. In later section, a more detailed description of their operation, their analysis and design equations are introduced.

### Continuous Input Current Topology

As seen in FIG. 1a this topology consists of an inductor in series with the input, an isolation transformer, the primary and secondary side floating energy transferring capacitors, a resonant inductor and three switches: a controllable active switch on the primary side and two passive diode switches on the secondary side and a PFC IC controller on the primary side. The active switch S on the primary side is modulated by controlling either ON time or OFF time as seen in FIG. 1b and operated at the switching frequency which is an order of magnitude higher than the AC line frequency, such as 20 kHz or higher switching frequency (switching period Tₛ of 20 μsec or less) compared to a low AC line frequency of 50 Hz or 60 Hz.

The input AC line voltage and AC line currents are sensed and sent as inputs to the PFC IC controller, which in turns modulates the switch S on the primary side so that the input AC line current is forced to be proportional to the AC line input voltage as illustrated in FIG. 1c and result in ideally desired Unity Power Factor.

The AC line current I_{AC} is clean and free from high frequency harmonics owing to the use of the Integrated Magnetics in the converter topology of FIG. 1a. By judicious design of Integrated Magnetics, the high switching frequency ripple is shifted to isolation transformer from the input inductor L to result in noise-free input AC line current.

### Pulsating Input Current Topology

As seen in FIG. 2a this topology consists of an isolation transformer, a secondary side floating energy transferring/resonant capacitor, a resonant inductor in series with it and three switches: a controllable active switch S on the primary side and two passive diode switches on the secondary side and a PFC IC controller on the primary side. The active switch S on the primary side is modulated by controlling either ON-time or OFF-time as seen in FIG. 2b and operated at the switching frequency which is an order of magnitude higher than the AC line frequency, such as 20 kHz or higher switching frequency (switching period T_{S} of 20 μsec or less) compared to a low AC line frequency of 50 Hz or 60 Hz.

The input AC line voltage and AC line currents are sensed and sent as inputs to the PFC IC controller, which in turns modulates the switch S on the primary side so that the input AC line current is forced to be proportional to the AC line input voltage as illustrated in FIG. 2c and result in ideally desired Unity Power Factor.

The AC line current IAC has a superimposed high switching frequency ripple on its average low AC line frequency. Therefore, an additional high frequency filter on input AC line is needed to filter that out and result in clean AC line current as in FIG. 1c.

### General Single-Stage AC-DC Conversion Method

As seen in FIG. 3a the general method consists of Single-Stage AC-DC power processing method which comprises a power stage with at least an isolation transformer and/or additional inductor and three switches, one controlling switch S on primary side and two passive diode switches on the secondary side and a PFC IC controller which controls the switch S as in FIG. 3b to force the AC input line current to be proportional to AC input line voltage as shown in FIG. 3c and results in ideally desired Unity Power Factor.

The Single-stage Isolated PFC method is operated directly from the AC line and converts input AC voltage directly to output DC voltage, while drawing the sinusoidal current from the line proportional and in phase with the line voltage. Clearly, such single stage Isolated PFC converter must fulfill some basic prerequisites such as:
1. Switching converter must be capable of accepting either the positive or the negative polarity of the input voltage.
2. Switching converter then must also act inherently as a rectifier stage (since bridge rectifier is eliminated!), which will for either polarity of the input voltage generate a single polarity output voltage.
3. Converter must have a DC voltage step-up gain characteristic as a function of duty ratio D, such as 1/(1−D) so that it can convert an AC input voltage to a DC voltage higher than the peak AC voltage.
4. The conversion ratio of the switching converter as a function of duty ratio D must be same for both positive and negative input voltage
5.Switching AC-DC converter must also inherently provide galvanic isolation.

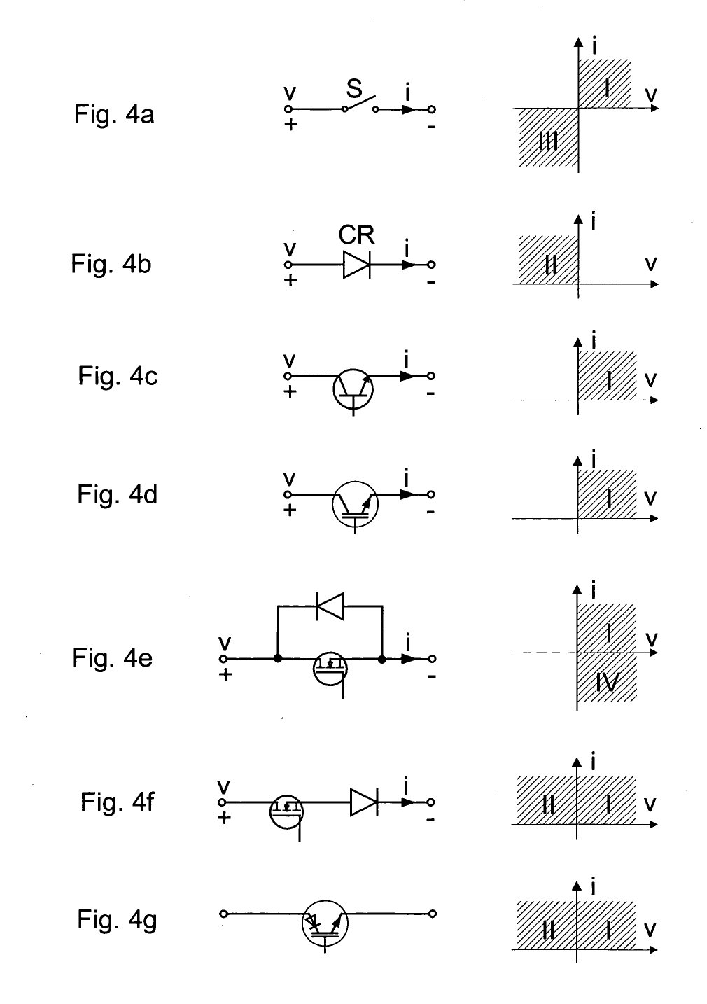

The controllable switch S can be implemented using several semiconductor active switch technologies. Thus, the quadrant classification of the switches and their implementation with existing semiconductor switching devices are introduced in FIG. 4a-g.

Prior-art AC-DC converters are introduced in next section.

### PRIOR-ART

### Power Factor Correction

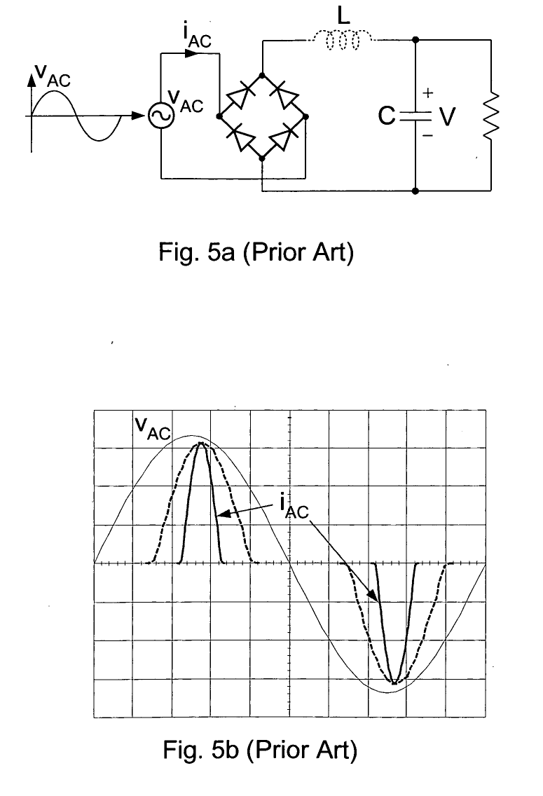

The present simplest AC/DC power conversion method uses a full bridge rectifier (four-diodes) to charge a large output capacitor so that a small ripple voltage would be obtained on DC voltage output V as shown in FIG. 5a. However, the current from the AC line is then drawn only during the short time while the peak of the input AC line voltage is higher than a DC voltage on the capacitor C (shown in FIG. 5b). This narrow and distorted input current pulse has two fundamental drawbacks:
a) a lot of high frequency current harmonics are generated and injected into the AC line side, which are not in compliance with requirements defined by the IEC 1000-3-2 harmonic currents standard.
b) a very low power factor is present, which significantly reduces the available real power from the utility line since the large reactive current generates high peak circulating and corresponding losses in transmission lines without delivering any power to the load. The above crude form of AC-to-DC power conversion is not allowed any more for applications requiring more than 75 W. Hence, some form of Power Factor Correction (PFC) and well-defined reduction of the Total Harmonic Distortion (THD) are mandated by regulations. A small improvement is possible with implementation of the output inductor L (shown in dotted lines on FIG. 5a and FIG. 5b), but this does not even come close to meeting the regulation requirements.

Therefore active methods of Power Factor Correction using Switching DC-to-DC converters must be used to provide near Unity Power Factor and galvanic isolation features. The three alternatives based on the number of power processing stages used are discussed bellow.

### Single-Stage Prior Art

There are no single-stage prior art solutions.

### Three-Stage Prior Art

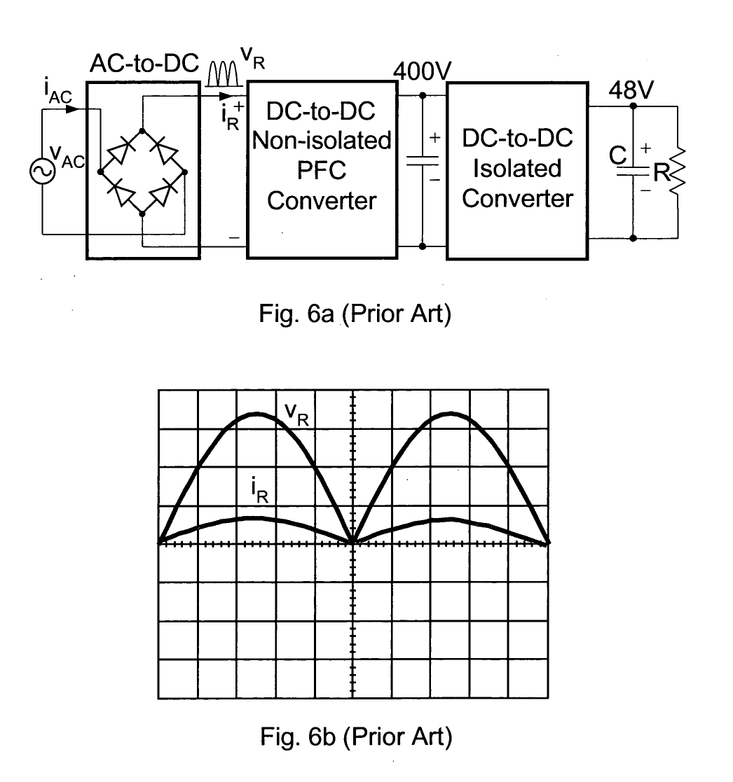

The three-stage prior-art AC-DC converter is shown in block diagram form in FIG. 6a to consists of three stages: full-bridge rectifier, a non-isolated DC/DC converter providing Power Factor Correction and an isolated DC-DC converter providing isolation and DC voltage step-down or step-up. The non-isolated PFC converter in FIG. 6a is therefore a DC-DC converter controlled in such a way to generate the rectified input current waveform i_{R} proportional to the rectified input voltage waveform v_{R} as seen in FIG. 6b. The full bridge on input then unfolds the rectified waveforms of FIG. 6b into an AC line current waveform i_{AC} proportional to the sinusoidal AC line voltage V_{AC} as seen before in FIG. 1c The output of the non-isolated PFC converter is therefore a semi-regulated DC voltage typically of 400V DC as illustrated in FIG. 6a. Finally a third-stage is needed to provide the isolation and voltage step-down or step-up function as illustrated in FIG. 6a. This solution is clearly undesirable as it consists of three cascaded power-processing stages: full-bridge rectifier, PFC boost converter and isolated DC-DC converter each of which simultaneously decreases the efficiency, increases the size and increases the cost. One of the objectives of this invention is to provide a single power processing stage with a minimum number of switches and minimum number of magnetics components which will provide both the PFC performance meeting regulatory requirements and the galvanic isolation but without the use of the front-end bridge rectifier and operate directly from AC line.

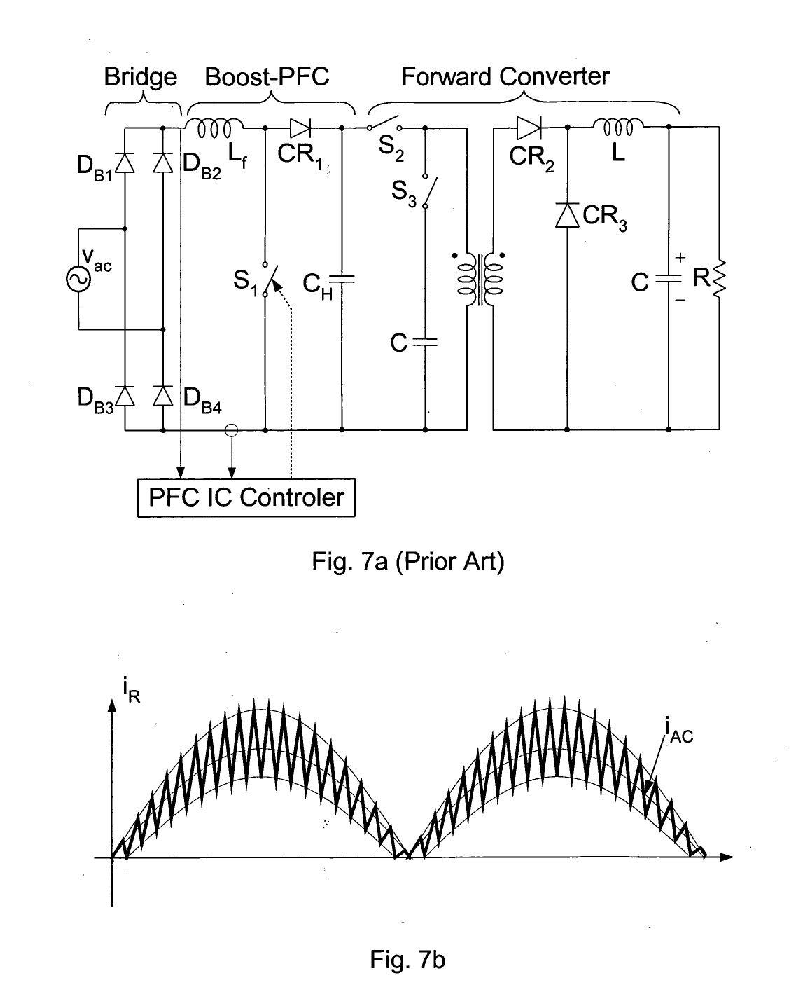

One specific example of this prior-art three-stage approach is illustrated in FIG. 7a in which the prior-art boost converter is used for Power Factor Correction and prior-art forward converter is used for isolation and step-down conversion. As seen, this approach uses a total of 10 semiconductor switches as opposed to the present invention of FIG. 1a which uses only three switches.

Furthermore, two switches in the boost converter and two switches of the forward converter must be high voltage switches of 400V and 800V voltage rating respectively. The present invention has two passive diode switches rated to the low output DC voltage and its input switch also with reduced voltage rating.

In addition, three-stage conversion requires four magnetic components: three displayed in FIG. 7a and a forth high frequency filter magnetics needed to eliminate high frequency ripple from the input current waveform of FIG. 7b. The present invention of FIG. 1b uses only one magnetic component.

The PFC IC controller of FIG. 7a results in rectified waveforms of FIG. 7b.

### Prior-art Boost PFC Implementation

The ideal DC conversion ratio of the boost converter is described by well-known equation:

V/V_{g}=1/(1−D) (1)

Prior-art boost DC-DC converter of FIG. 7a also requires a use of the full-bridge rectifier in front of it to perform Power factor Conversion.

Prior-art boost converter used as a PFC converter in FIG. 7a is shown with its front-end full bridge rectifier. In addition to boost converter losses, the input alternating current must first pass also through the two diodes of the bridge rectifier for either positive or negative part of an AC cycle. The corresponding two-diode voltage drops at low AC line voltage of 85 V_{AC} result in additional 3% losses. Clearly, eliminating the full-bridge rectifier and operating directly from the AC line would result in a true bridgeless PFC converter with several benefits:
a) Elimination of high losses of the full-bridge rectifier;
b) Reduced size and cost.

### Other Prior-Art Non-Isolated PFC Converters

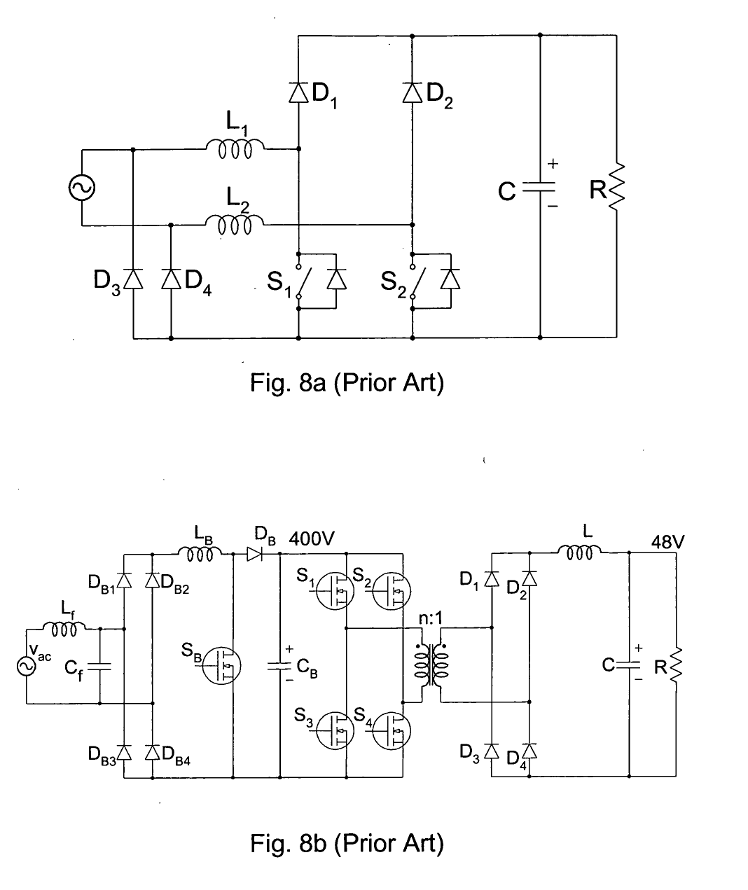

A number of prior-art PFC converters were proposed in the past to remedy the problem of the full-bridge rectifier and reduce the number of diode voltage drops in the power path and thus to increase the overall efficiency. However, they all failed to achieve the desirable goal of eliminating input bridge as they operate only from the positive polarity of the input voltage. Therefore, prior-art alternatives could not accomplish the bridgeless PFC operation by using existing DC-DC converter structures due to their inability to accept the input voltage of either polarity (positive or negative) and yet generate the output voltage of only one polarity, such as positive. Various methods were employed by prior-art PFC converters to claim bridgeless PFC operation by making modifications of the well-known dual-boost converter of FIG. 8a.

Prior-art dual boost converter of FIG. 8a employs two complete boost converters, one for each of the AC input voltage cycles. Although the claims are made that it is a bridgeless converter, this is easily seen to be false, as the two low frequency diode rectifiers D₃ and D₄ of the four diodes in full-bridge rectifiers are still retained causing aforementioned losses. Therefore, in addition to the reduced efficiency due to additional diode drops (only half of the diodes in the full-bridge are eliminated), it also suffers from doubling the number of components and cost in comparison to the previous prior-art single boost PFC converter. Thus, the components in double-boost converter of FIG. 7a are poorly utilized as they are used only half of the time resulting in serious penalty in weight, size and cost, while only marginally improving efficiency by eliminating one diode voltage drop for each half cycle. The present invention eliminates entirely the full-bridge rectifier as disclosed herein and is therefore a genuine Bridgeless PFC converter, and in addition provides the galvanic isolation as well.

### Other Prior-Art Isolated DC-DC Converters

Instead of the forward converter in FIG. 7a, for higher output powers of several KW, the phase-shifted full-bridge converter is used to result in another three-stage solution in FIG. 6a. In this case a total of 14 semiconductor-switching devices is used and four magnetic components as seen in FIG. 8b.The present invention of FIG. 2a uses three switches only and one magnetic component.

### Two-Stage Prior-Art

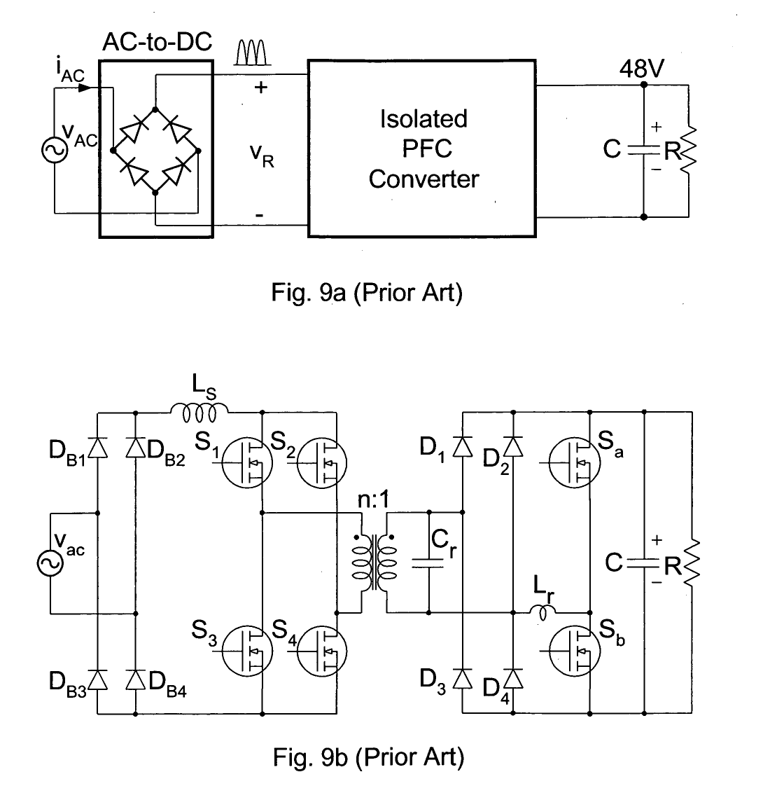

Two-stage prior-art solution is illustrated in FIG. 9a in which the second stage is n Isolated DC-DC converter having a boost-type DC conversion gain given by (1) and therefore capable of Power Factor Correction. An example of the isolated Boost converter is a Full-Bridge Isolated Boost Converter illustrated in FIG. 9b employing additional two transistors on secondary side to reduce switching losses. Despite the two-stage approach, this solution has even larger number of switching devices, a total of 14 switching devices. Although one magnetics device is eliminated (the output inductor present in previous solutions), it still has four magnetic devices, due to the use of the resonant inductor on the secondary side.

Single-Stage Isolated Bridgeless PFC control

The single-stage Isolated PFC converter does not have a bridge rectifier so the control is as illustrated by the block diagram of FIG. 3a. The AC line voltage is sent directly to the bridgeless PFC converter to convert it to DC output.

In addition to a Bridgeless PFC Converter stage as shown in FIG. 3a corresponding new Isolated Bridgeless PFC controller IC is needed, which accepts as inputs the AC voltage directly and senses AC input current and controls the modulation of the high frequency switches in Isolated Bridgeless PFC Converter to force the input AC current to be proportional input AC voltage.

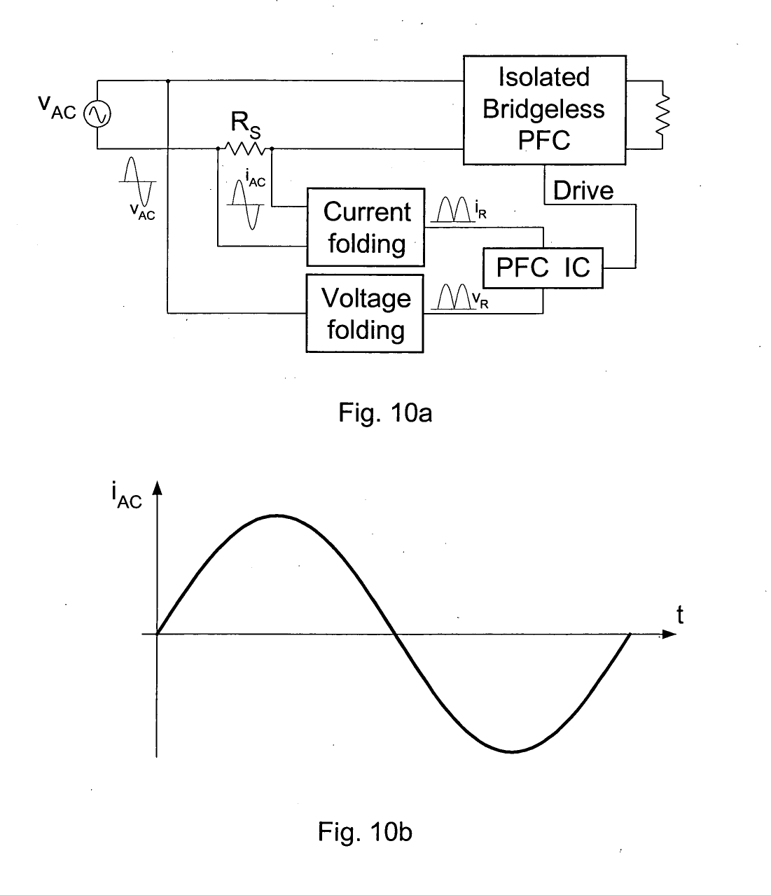

Such Bridgeless PFC Integrated Circuit Controllers do not exist currently. However, the existing PFC controller chips operating from rectified AC line voltage and rectified AC line current could be used provided additional signal processing circuitry is implemented as shown in FIG. 10a. The additional circuitry recreates the rectified AC line voltage and rectified AC line current from the direct full wave AC line voltage and AC line current to result in AC line current of FIG. 10b.

### BRIEF DESCRIPTION OF OPERATION

The isolated embodiments of the Single-Stage AC-DC converters are first reduced to their non-isolated parts by elimination of the isolation transformers in the AC-DC converter of FIG. 1a and FIG. 1b which will preserve their main features: operation directly from the AC line and Power Factor Correction (PFC) ability. Thus, first these non-isolated extensions will be introduced and analyzed in details. Then their isolated versions will be reintroduced to highlight the particular features of the isolation transformers utilized in respective AC-DC converters.

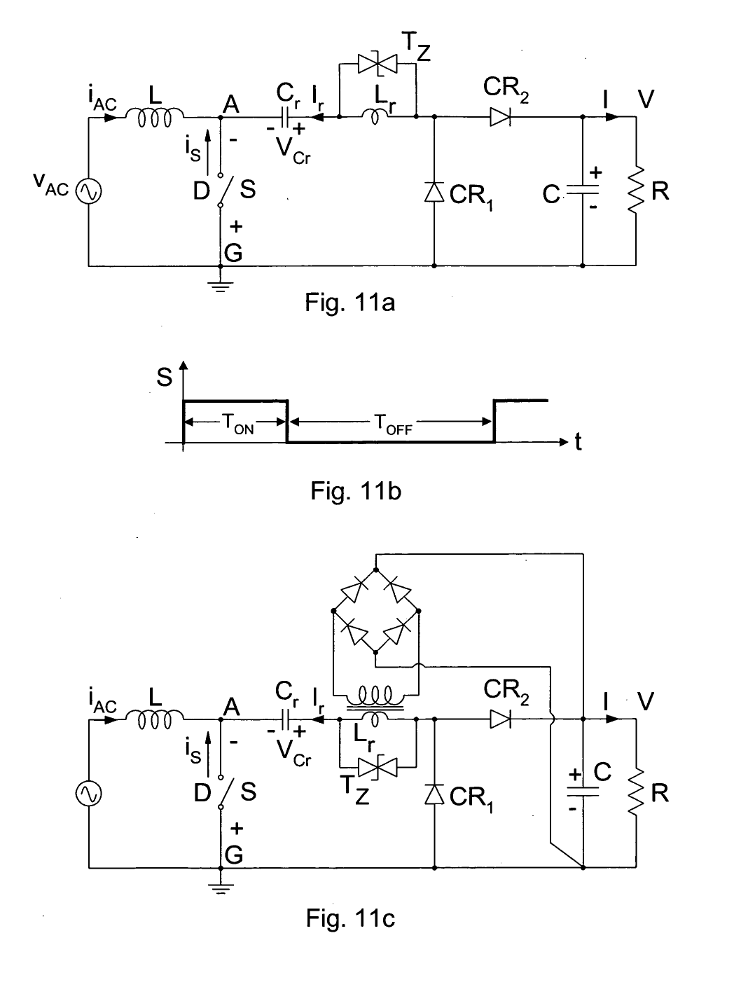

First we analyze the non-isolated version of the AC-DC converter in FIG. 1a. Since the isolation transformer does not have a DC bias as it is capacitively coupled on both primary and secondary side such as Isolated Cuk converter, the isolation transformer could be first reduced to a large magnetizing inductance, which can be removed as having negligible impact on basic converter operation. The remaining two capacitors in series Cᵣ₁ and Cᵣ₂ could then be replaced with a single resonant capacitor Cᵣ to result in the non-isolated extension shown in FIG. 11a of the Isolated AC-DC converter of FIG. 1a.

The non-isolated converter in FIG. 11a also satisfies the Single-Stage AC-DC Conversion Method requirements (Bridgeless PFC) and employs the corresponding Hybrid Switching method described above. It consists of three switches: one active controlling switch S whose ON-time modulation is illustrated in FIG. 11b and two passive diode rectifier switches CR₁ and CR₂, which are turning ON and OFF in response to the state of the main switch S for either positive or negative polarity of the input AC voltage. As the input voltage polarity changes, the minimal implementation of the switch S is that it must be voltage bi-directional, that is it should be able to block either voltage polarity of the input AC voltage and conduct current correspondingly when it is turned-ON (current bi-directional!). If no single semiconductor switch can perform such function a composite switch can be made out of existing active switching devices, as illustrated later.

Note that the odd number of switches, three (3), is already a distinctive characteristic of this converter with respect to all conventional switching converters, which always come with an even number of switches, such as 2, 4, 6 etc. This was dictated by the requirement of square-wave switching using both inductive and capacitive energy transfers (often called PWM switching), which requires that the switches come in complementary pairs: when one switch is ON its complementary switch is OFF and vice versa. This, in turn, is consequence of the fact that when inductances store energy capacitances are releasing stored energy and vice versa.

Here no such complementary switches exist, as one active switch S alone is controlling both diode switches, not only for positive polarity of input voltage AC line voltage but also for negative polarity of input voltage.

Note that this is accomplished with the fixed topological connection of the two current rectifiers, which automatically change their ON-time intervals and OFF-time intervals as needed by the polarity of the input AC voltage. For example, for the positive polarity of the AC input voltage, current rectifier CR₁ conducts during the ON-time interval of switch S. Then for negative polarity of AC input voltage, the same current rectifier conducts during the OFF-time interval of controlling switch S. The current rectifier CR₂ also responds automatically to the polarity of the input AC voltage. For the positive polarity it is conducting during OFF-time interval of switch S and for negative polarity it is conducting during the ON-time interval of switch S.

Described from the switch S controlling point of view:
a) for positive polarity of input AC voltage, turning ON of switch S forces current rectifier CR₁ to turn-ON and simultaneously forces current rectifier CR₂ to turn OFF
b) for negative polarity of input AC voltage, turning ON of switch S forces current rectifier CR₂ to turn-ON and simultaneously forces current rectifier CR₂ to turn OFF.

Thus, unlike in prior-art double boost converter, the three switches are operating at all times, for both positive and negative cycles of the input AC line voltage. The same is true for a single input inductor L, whereas, the dual boost (or double boost) of FIG. 6a uses two PWM boost inductors, each of which is used only half of the time. Hence in present invention the component utilization is 100% and cost is reduced more than two times in comparison with double-boost PFC converter. Simultaneously the size is reduced by at least two times. The efficiency is simultaneously increased as well, especially for the low line of 85 VAC since the full bridge rectifier is eliminated.

The converter in FIG. 11a has also an energy transferring capacitor, which during the OFF-time interval T_{OFF} charges and at the same time passes the input charging current to the load. Then during the ON-time interval T_{ON} this capacitor forms a resonant circuit with the resonant inductor Lᵣ and exchanges the energy stored in previous OFF-time interval with resonant inductor. This resonant inductor is much smaller than PWM inductor L, since its AC flux is one to two orders of magnitudes smaller than the AC flux of PWM inductor L resulting in a very small magnetic core needed for its implementation. As a result, it stores a much less inductive energy than the PWM inductor. Nevertheless the current direction in this inductor is changing form one direction in OFF-time interval to another direction in ON-time interval. This change of the direction of inductor current during the short transition would cause the voltage spike on the switch S. The faster the change, the bigger the voltage spike would be. However, due to small energy stored in this small inductor, this spike can be effectively suppressed by use of a Zener diode, which would limit the voltage spike but dissipate the energy in Zener diode. Since the converter operates for both polarities of the input voltage, the bi-directional Zener diode, called Transorber is used and marked with T_{Z} in FIG. 11a. This, once again would dissipate all of the spike energy and limit the spike voltage.

The dissipative loss can be much reduced by use of the energy recovery switching circuit, such as for example one illustrated in the converter of FIG. 11c. The resonant inductor has an additional secondary winding which through a full-bridge diode rectifier connected to the secondary winding is releasing that energy to the load. Clearly, since the energy in this transitional change is very small, both the secondary winding and diode-bridge are rated only to the small recovery energy they are processing. Thus a low power, small full-bridge diode rectifier packaged in a small chip could be used to minimize space used for this energy recovery network. To simplify further presentations, the converter schematics will omit these energy recovery-switching circuits and show various converter extensions using only a transorber T_{Z}. However, this and other energy-recovering network that one skilled in the art might devise, could be used in all of them in order to increase the efficiency.

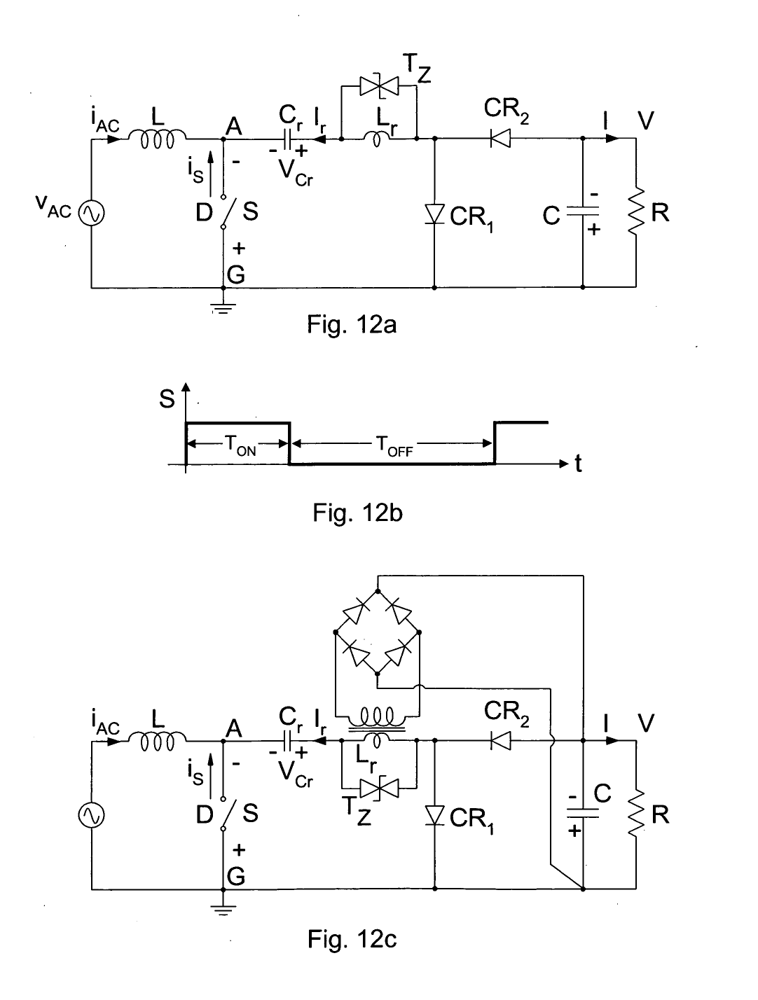

The direct AC-to-DC converter of FIG. 11a has another feature not present in current DC-DC converters. Since the input voltage is AC, the output DC ground could be selected to be at positive output terminal so that negative output DC voltage is obtained with respect to DC ground. Alternatively, the diode directions in FIG. 11a could be reversed to result in the converters of FIG. 12a and FIG. 12c.

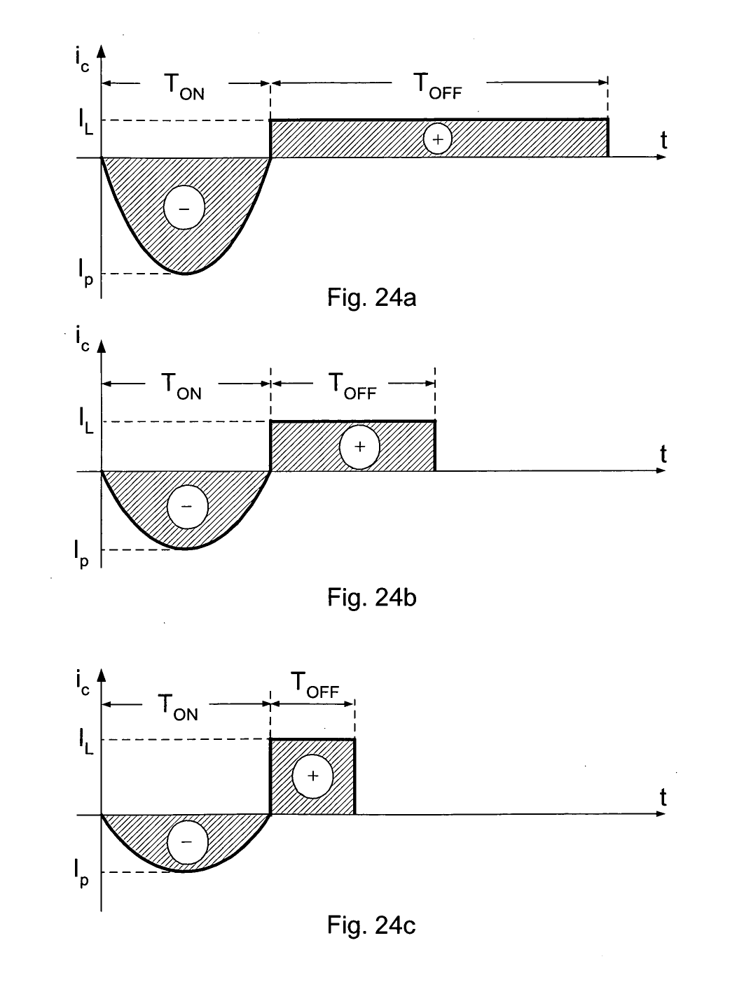

The switch S in FIG. 11a is a two-quadrant switch operating in first and third quadrant (FIG. 24a). Thus, for positive input voltage it can block the voltage of positive polarity and conduct the current in one direction when turned ON. However, for negative input voltage, it can block the voltage of opposite polarity and conduct the current in opposite direction when turned ON, just as operation in quadrants I and III suggests (FIG. 24b). Switch S is turned ON for controlling ON-time interval T_{ON} for both positive and negative input voltage polarity.

The current rectifiers, however, change their roles automatically, depending whether the input voltage is positive or negative as described above. In conclusion, the unique converter topology in conjunction with the single resonant inductor L₁ results in implementation of three switches (one active two-quadrant switch and two passive, single quadrant current rectifier switches) is one of several reasons that a single-stage Bridgeless AC-DC converter is made possible. The second reason is that a single input inductor L generates in conjunction with the above switching action, the needed step-up conversion function for either polarity of input voltage. The third reason is the presence of the resonant inductor Lᵣ placed in series with the resonant capacitor Cᵣ, resulting in hybrid switching operation described above, which is the method enabling the same step-up voltage gain for either of the two input voltage polarities as detailed analysis enclosed reveals.

### Detailed Description of Converter Operation

One of the key characteristics of the new Bridgeless PFC converters of FIG. 11a and FIG. 12a is that the switching converter is inherently capable of operating from either positive or negative input voltage. Thus we will explain separately first the operation from the positive input voltage and then from the negative input voltage to obtain the basic understanding of the operation of converter under two different input voltages, positive polarity and negative polarity input DC voltage. This will then be followed by the derivation of the conversion DC gain characteristics and resonant circuit analyses. Finally, with operation under either positive or negative input voltages fully analytically characterized and understood, the operation from AC line voltage under PFC control will be the easier to understand.

Here is a brief description of the converter operation, first for positive input voltage and then for negative input voltage.

Operation from Positive Input Voltage

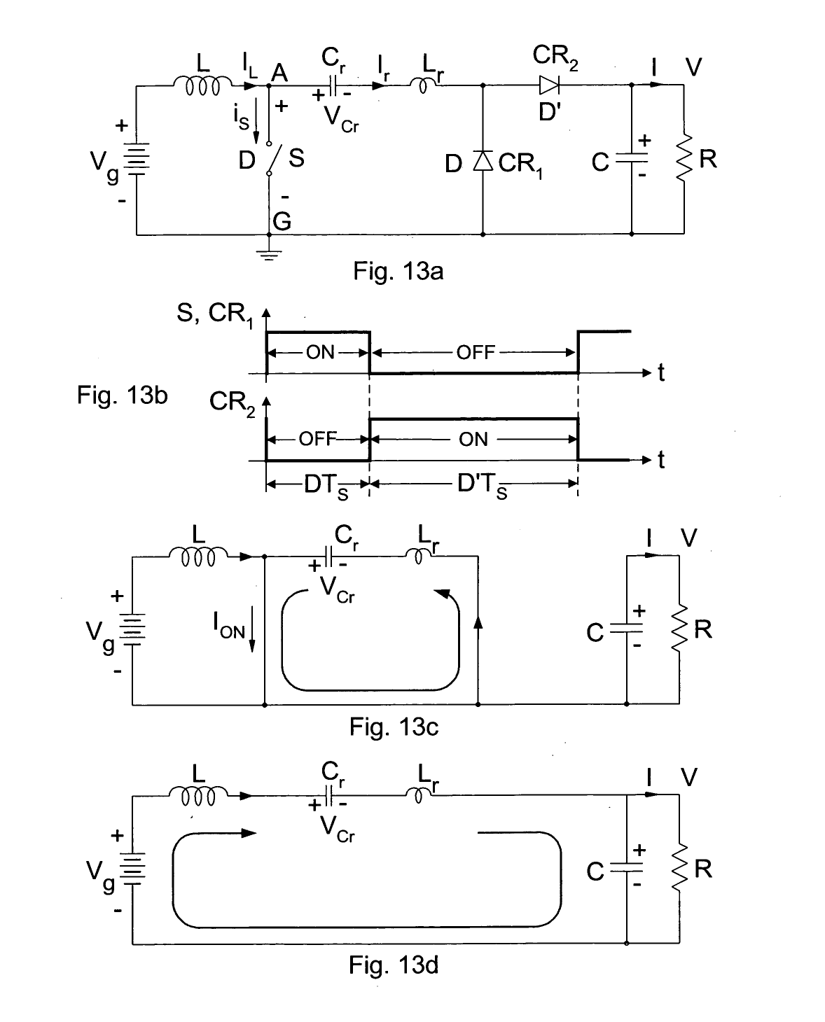

First we analyze the converter operation with respect to the converter in FIG. 13a in which input voltage source is positive polarity DC voltage and having the switch states as in FIG. 13b. The linear switched networks for ON-time interval is shown in FIG. 13c and linear switched network for OFF-time interval is shown in FIG. 13d. To simplify the analysis, we will assume that the inductor L is very large resulting in a constant input DC current I with negligible AC ripple current.

When switch S is turned-OFF (FIG. 13d), the DC current I of input inductor L forces the rectifier CR₂ to turn-ON and capacitance Cᵣ is charging while the load current was provided from the input voltage source. Subsequent turn-ON of switch S (FIG. 13c) causes the rectifier CR₁to turn-ON and capacitor Cᵣ exchanges its previously stored energy in a no-dissipative resonant fashion with the resonant inductor. If this resonant inductor were not present, the energy stored in resonant capacitor would during this interval be dissipated and lost in parasitic ESR of the capacitor. This would clearly result in the reduced efficiency. Therefore, the resonant capacitor (and resonant inductor) even though not transferring the current to the load is not wasted, since the resonance is used to prepare the capacitor for the next charging interval in next cycle.

### PWM Inductor Voltage and Current Waveforms

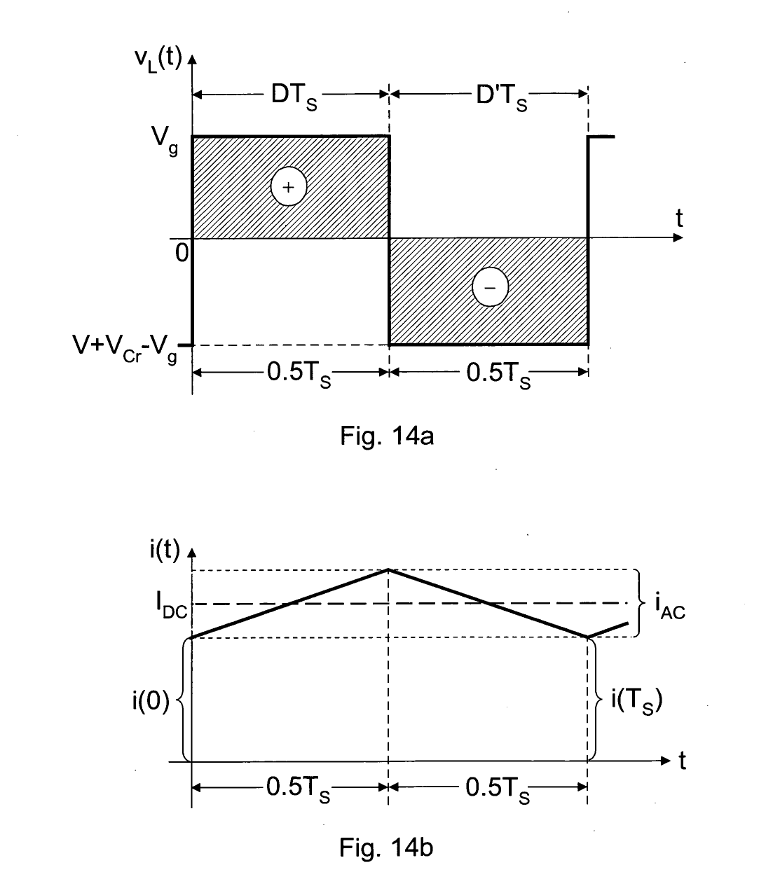

We now use the two linear switched networks in FIG. 14c and FIG. 14d to construct the time domain of the currents in the PWM inductor L and in the resonant inductor Lᵣ. Voltage waveform on inductor L can be constructed from two linear networks to be as shown in FIG. 14a from which the time domain of inductor current is easily reconstructed as to consists of the triangular ripple current superimposed on the input DC current level I_{DC} as illustrated in FIG. 14b just as in conventional square-wave switching converters.

The Volt-second (flux balance) on inductor L requires that for the steady-state, the positive and negative areas of the voltage waveform in FIG. 13a must be balanced so that:

V_{g}DT_{S}=(V+V_{Cr}−V_{g}) (1−D)T_{S} (2)

### Resonant Inductor Voltage and Current Waveforms

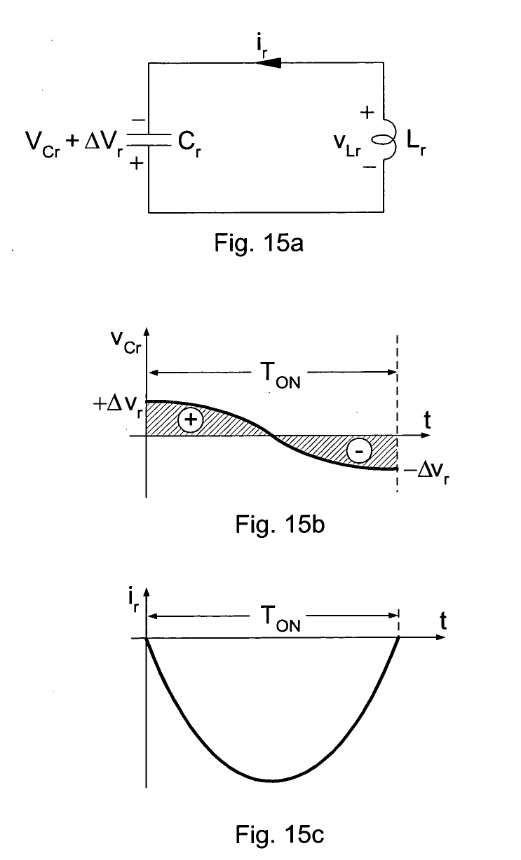

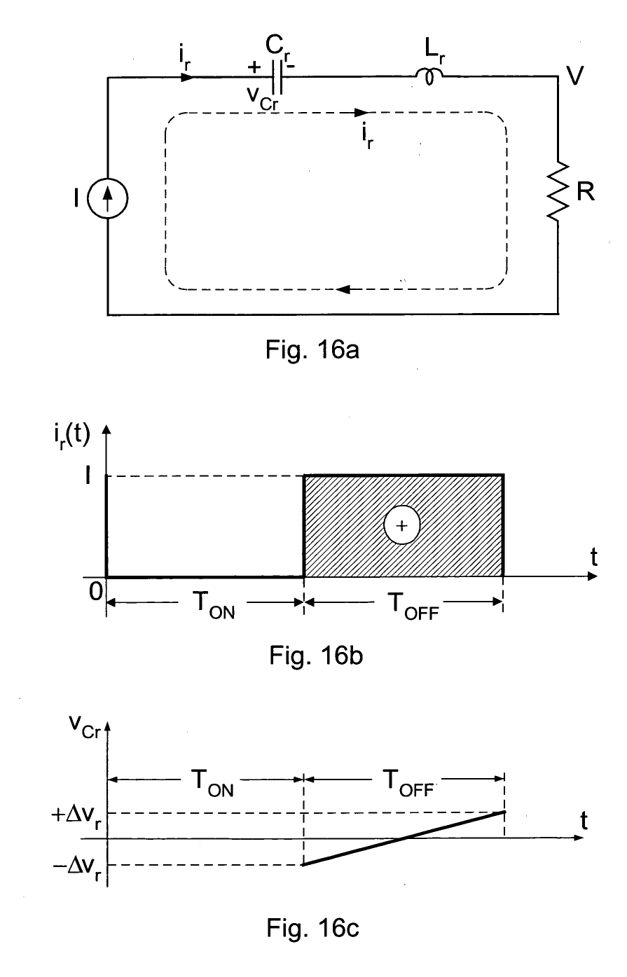

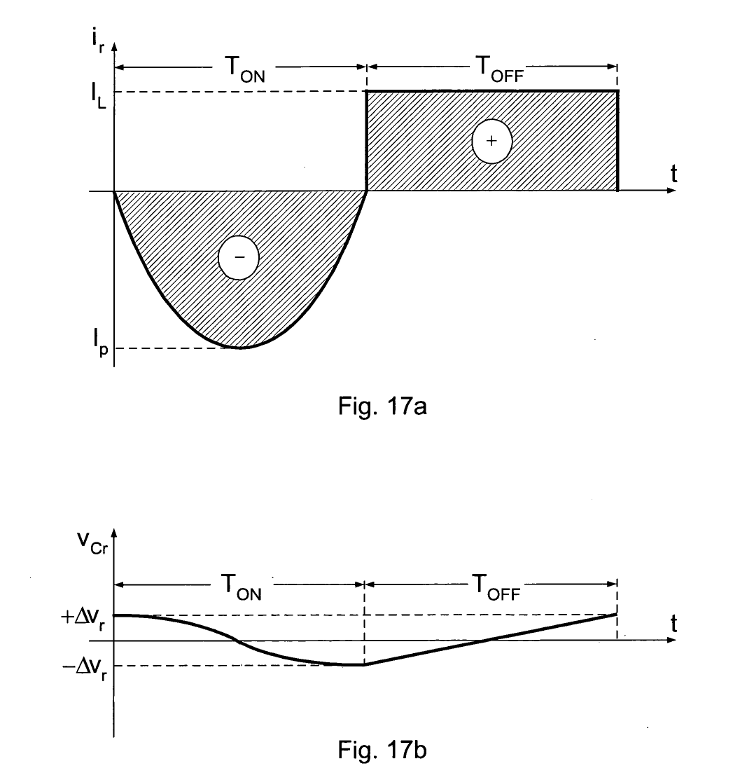

To reconstruct the resonant inductor current iᵣ waveform in the time domain requires analyzing separately the two circuit models derived from the equivalent circuits in FIG. 13c and FIG. 13d for the resonant inductor current as follows:
a) equivalent circuit for the ON-time interval shown in FIG. 15a;
b) equivalent circuit model for the OFF-time interval shown in FIG. 16a.
Unlike the PWM inductor, which was flux balanced over the entire period T_{S}, the resonant inductor must be fully flux balanced during the ON-time interval only as per resonant circuit Model of FIG. 15a. Thus applying the steady-state criteria for the resonant inductor Lᵣ results in:

V_{Cr}=0 (3)

as the resonant inductor must be flux-balanced and cannot support any net DC voltage since the integral of the AC ripple voltage Δvᵣ over the ON-time interval must be by definition zero. Therefore, the DC voltage V_{Cr} of the resonant capacitor Cᵣ must be zero so that the volt-second balance is satisfied on the resonant inductor Lᵣ. If this converter, for example, is operated just as the boost converter, despite the large input and output DC voltages, the DC voltage of resonant capacitor Cᵣ will still be zero. The ceramic chip capacitors for example, have their capacitance values inversely proportional to their DC voltage ratings. The same size chip capacitors have a lot higher capacitance value for lower voltage ratings. The lower DC voltage the higher the capacitance value in the same package and correspondingly higher current handling capacity. This is a bonus from the present invention when operated from the positive DC input voltage, such as the replacement for the prior art boost converter of FIG. 4a.

### DC Conversion Ratio

Using the result (3) in (2), the DC conversion ratio is obtained as:

V/V_{g}=1/(1−D) (4)

Note that the same DC conversion ratio of the prior-art boost converter as in (1) is obtained. Furthermore, despite the resonant circuit consisting of resonant capacitor Cᵣ and resonant inductor Lᵣ, the DC conversion does not depend on either one of them and their values or the switching period T_{S}, but only depends on the operating duty ratio D. Thus despite hybrid switching, the simple DC conversion ratio as in square-wave switching is obtained. Hence, the regular duty ratio control can be employed to use this converter as a basis for PFC control as in prior-art boost converter. However, unlike prior-art boost converter, this converter will accept both positive and negative polarity input voltage. However, to achieve that function, we need to prove that the same DC conversion ratio as in (4) will also be obtained for operation with negative polarity input DC voltage source.

We now postpone the detailed analysis of the resonant circuit and development of analytical results which will describe the resonant voltage and current waveforms of FIG. 15b and FIG. 15c for later section on Resonant Circuit Analysis.

### Analysis of the Circuit During OFF-Time Interval

Equivalent circuit during the OFF -time interval is shown in FIG. 16a in which large inductor L is replaced by the constant current source I_{L} to result in constant inductor current iᵣ(t) as in FIG. 16b and in linearly increasing AC ripple voltage on capacitor V_{Cr} as seen in FIG. 16c.

The waveforms over the complete period for resonant inductor current iᵣ(t) and resonant capacitor voltage v_{Cr}(t) are then illustrated in FIG. 17a and FIG. 17b. Note how the continuity of the voltage on resonant capacitor Cᵣ results in the same AC ripple voltage Δvᵣ at the transition between two intervals.

Operation from Negative Input Voltage

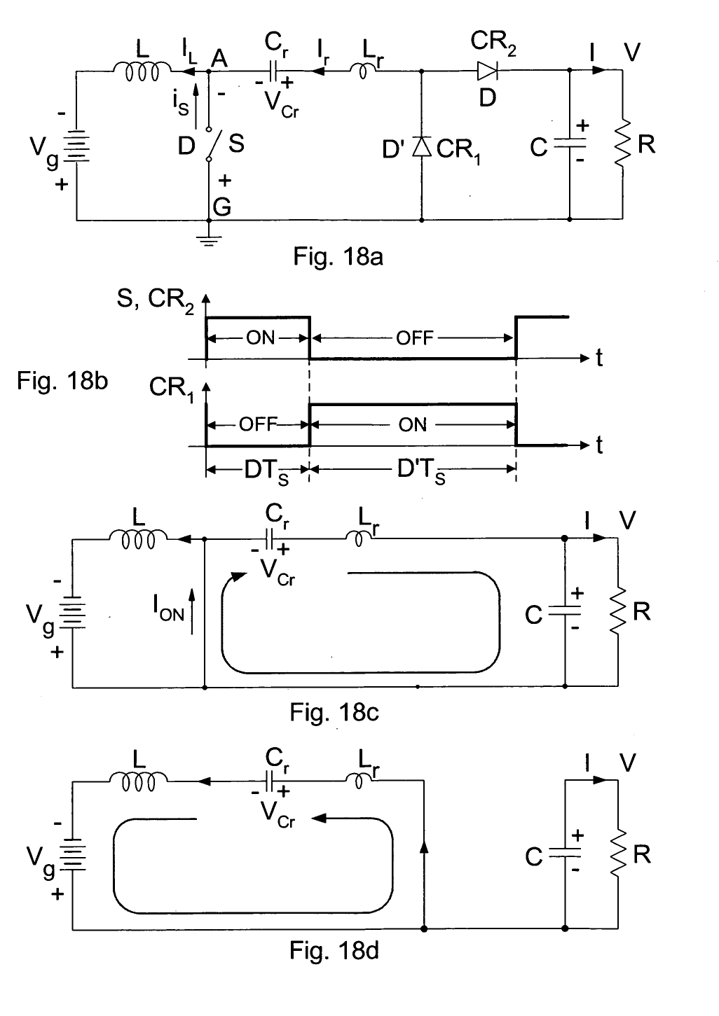

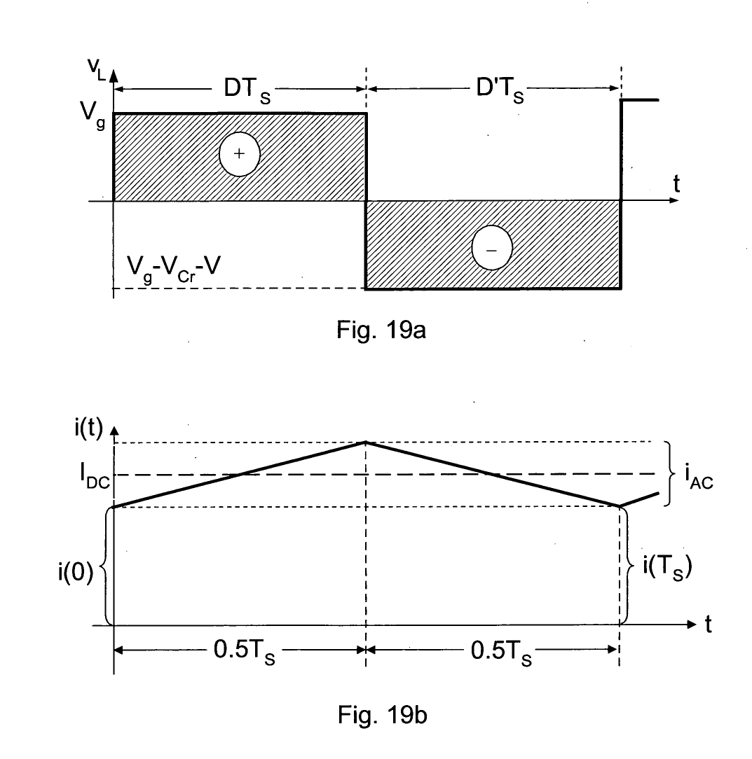

Next we analyze the converter operation with respect to the converter in FIG. 18a in which input voltage source is negative polarity DC voltage and having the switch states as in FIG. 18b. The linear switched networks for ON-time interval is shown in FIG. 18c and linear switched network for OFF-time interval is shown in FIG. 18d. As before to simplify the analysis, we will assume that the inductor L is very large resulting in a constant input DC current I with negligible AC ripple current.

### PWM Inductor Voltage and Current Waveforms

We now use the two linear switched networks in FIG. 18c and FIG. 18d to construct the time domain of the current in the PWM inductor L and in the resonant inductor Lᵣ. Voltage waveform on inductor L can be constructed from two linear networks to be as shown in FIG. 19a from which the time domain of inductor current is easily reconstructed as to consists of the triangular ripple current superimposed on the input DC current level I_{DC} as illustrated in FIG. 19b just as in conventional square-wave switching converters.

The Volt-second (flux balance) on inductor L requires that for the steady-state, the positive and negative areas of the voltage waveforms in FIG. 19a must be balanced so that:

V_{g}DT_{S}=(V_{Cr}−V_{g})(1−D)T_{S} (5)

### Resonant Inductor Voltage and Current Waveforms

To reconstruct the resonant inductor current iᵣ waveform in the time domain requires analyzing separately the two circuit models derived from the equivalent circuits in FIG. 18c and FIG. 18d for the resonant inductor current as follows:

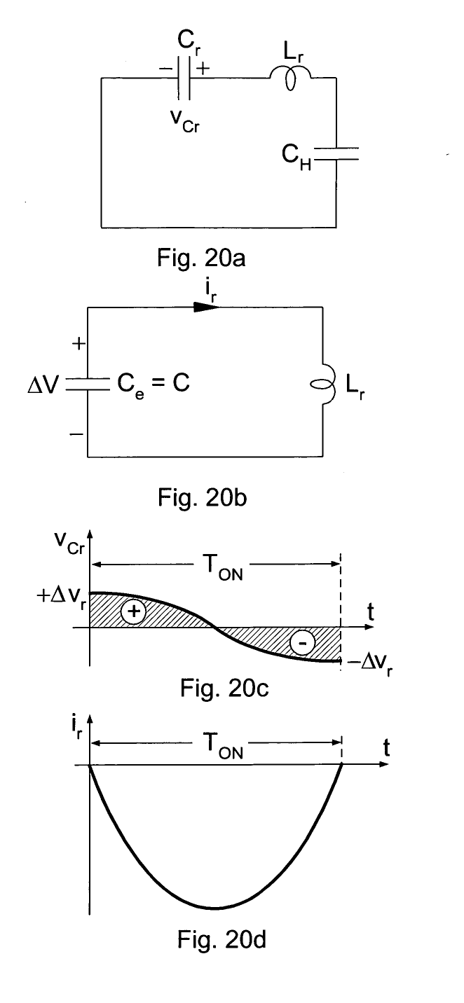

c) equivalent circuit for the ON-time interval shown in FIG. 20a;

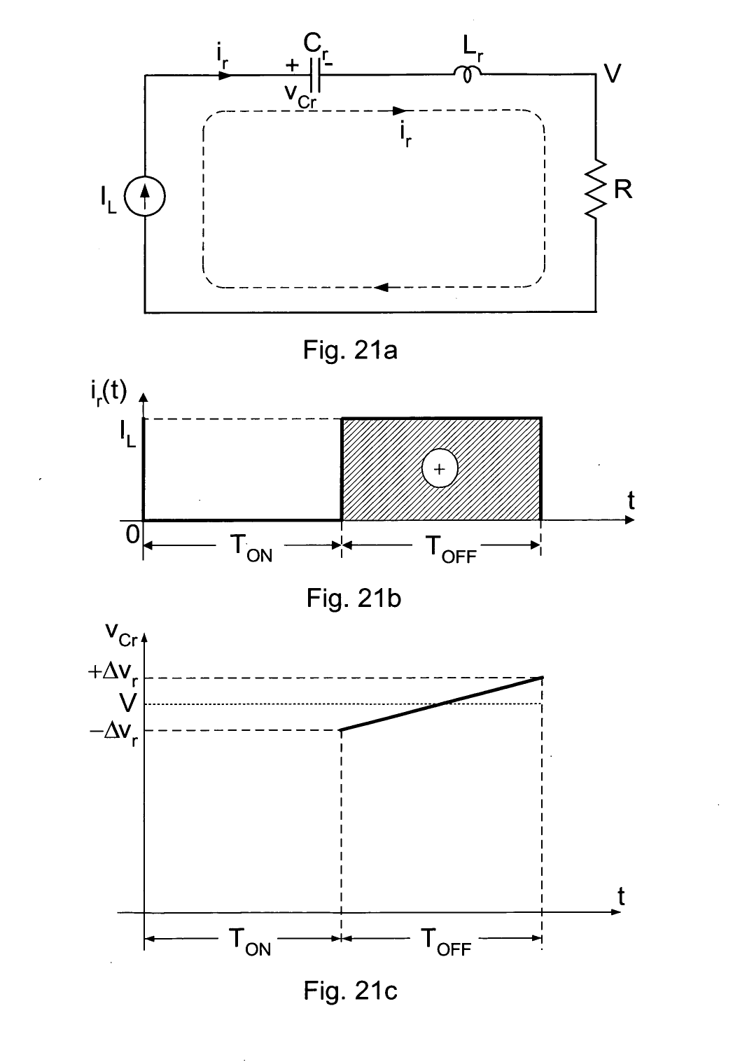

d) equivalent circuit model for the OFF-time interval shown in FIG. 21a.

Unlike the PWM inductor, which was flux balanced over the entire period T_{S}; the resonant inductor must be fully flux-balanced during the ON-time interval only as per resonant circuit model of FIG. 20a.

The resonant circuit model of FIG. 20a is now formed by the loop consisting of three components, two capacitors Cᵣ and C and resonant inductor Lᵣ, switch S and current rectifier CR₂. However, since the output capacitor C is much larger than the resonant capacitor Cᵣ, their series connection is effectively equal to Cᵣ as per:

1/Cₑ=1/Cᵣ+1/C=1/Cᵣ (6)

The resonant circuit for positive input voltage had only one capacitor, resonant capacitor Cᵣ. On the other hand the resonant circuit for negative input voltage has two capacitors in series. However, because of the above relationship (6), they reduce effectively to the resonant circuit shown in FIG. 20b. Moreover, due to the automatic changeover of the roles of the two current rectifiers from positive polarity input voltage to negative polarity input voltage, this results in the resonant circuit of FIG. 19b to be applicable to the same ON-time interval for either polarity of input voltage. The resonant circuit will therefore result in resonant capacitor voltage as in FIG. 19c and in the resonant inductor current as in FIG. 19d as was obtained before for positive input voltage. This will result in DC voltage step-up gain conversion ratio 1/(1−D) for either polarity of the input DC voltage as the following analysis reveals.

### DC Conversion Gain

The resonant inductor Lᵣ must be once again fully flux-balanced during the same ON-time interval DT_{S} only, which results from circuit model in FIG. 18c:

V_{Cr}=V (7)

as the resonant inductor cannot support any net DC during this ON-time interval.

Note that the steady state DC voltage on the resonant capacitor has changed from (3) to (7), that is from V_{Cr}=0 to V_{Cr}=V.

Replacing now (7) into (5) we get the DC conversion ratio for the negative input voltage as:

V/V_{g}=1/(1−D) (8)

which is the same as (4) for positive input DC voltage.

Therefore, despite different DC voltages on the resonant inductor for positive input voltage, (zero) and for negative input voltage (output DC voltage), the DC conversion gain functions are equal.

As before, the capacitor Cᵣ resonant discharge current iᵣ is limited to only a positive cycle of resonant current as current rectifier CR₂ now permits conduction in only one direction as in FIG. 20d. As the resonant current starts at zero level, this effectively constricts the resonant discharge interval once again to exactly one-half of the resonant period, same as before.

Analysis of the Circuit During OFF-time interval

Equivalent circuit during the OFF-time interval is shown in FIG. 20a in which large inductor L is replaced by the constant current source I_{L} to result in constant inductor current iᵣ(t) as in FIG. 21b and in linearly increasing AC ripple voltage on capacitor v_{Cr} as seen in FIG. 21c. Note, however, that the resonant capacitor has a DC voltage equal to output DC voltage V and not zero as before.

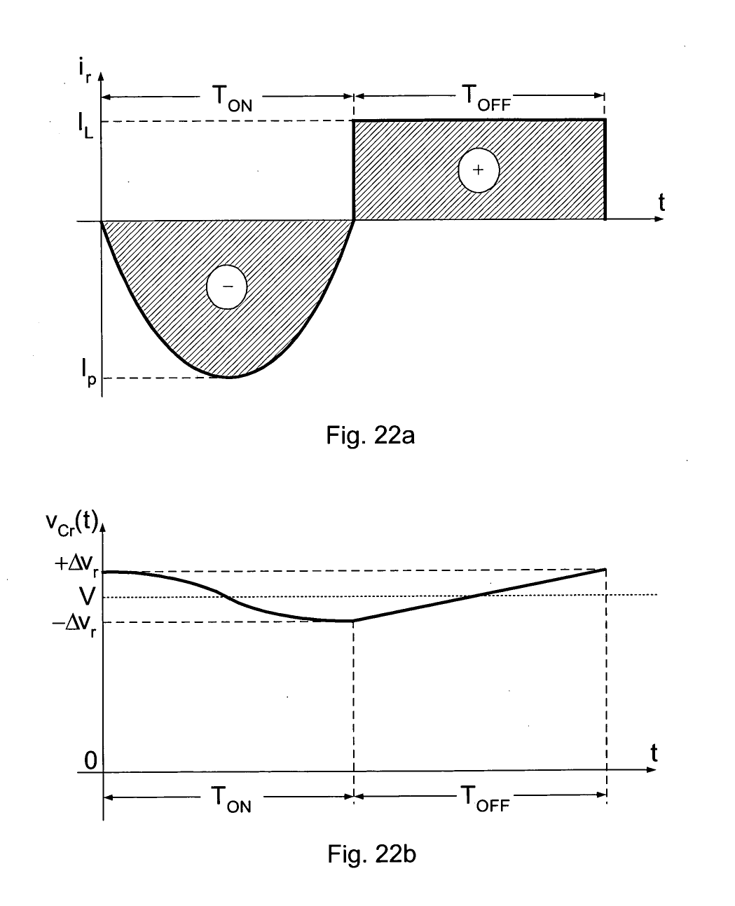

The waveforms over the complete period for resonant inductor current 40 and resonant capacitor voltage v_{Cr}(t) are then illustrated in FIG. 22a and FIG. 22b. Note how the continuity of the voltage on resonant capacitor results in the same AC ripple voltage Δvᵣ at the transition between two intervals. Once again, the resonant capacitor DC voltage is not any more zero but equal to output DC voltage V.

Thus, the same DC conversion gain function is obtained despite drastically different steady-state values of DC voltage on capacitor C equal to zero for positive input, and equal to output DC voltage V for negative input. Despite the different resonant circuits used for discharge of resonant capacitor Cᵣ during ON-time interval due to (6), the resonant inductor currents and resonant capacitor AC ripple voltages will be subject to the same analytical model derived bellow and therefore result in same analytical equations. However, for negative input voltage, the AC ripple voltage on resonant capacitor will be superimposed on DC voltage equal to V (output DC voltage) whereas for positive input DC voltage resonant capacitor DC voltage is zero.

A resonant capacitor the resonant capacitor derived from the same analytical equations time domains will be derived for both cases derived from derived resonant currents. Note also how the current rectifiers also change automatically their respective switching intervals to accommodate such unique operation.

### Resonant Circuit Analysis

As seen above, operation of the converter from positive input voltage and negative input voltage, results in the resonant circuit models, which can be both described by the same first order differential equations introduced below for the same ON-time interval.

For simplicity, and without loss of generality, we assumed that the input inductor current I_{L} is large so that the superimposed ripple current is negligible and can be considered constant at the DC level I_{L}. In order to find the resonant current waveforms displayed in FIG. 15b and FIG. 15c for positive input voltage and FIG. 20c and FIG. 20d interval for negative input voltage we need to solve the two first order differential equations for the resonant circuit models of FIG. 15a and FIG. 20b given by:

Cᵣ dv_{Cr} dt=−iᵣ (9)

Lᵣ diᵣ/dt=v_{Cr} (10)

Resonant circuit equations (9) and (10) subject to the initial conditions imposed during the previous OFF-time interval given by:

iᵣ(0)=0 (11)

v_{Cr}(0)=Δvᵣ (12)

The resonant solution is obtained as:

iᵣ(t)=I_{P} sin(ωᵣt) (13)

v_{Cr} (t)=Δvᵣ cos(ωᵣt) (14)

Δvᵣ=I_{P} R_{N} (15)

R_{N}=·LᵣCᵣ (16)

Where R_{N} is the natural resistance and

ωᵣ=1/√LᵣCᵣ (17)

fᵣ=ωᵣ/(2 π) (18)

where fᵣ is the resonant frequency and ωᵣ radial frequency.

The initial voltage Δvᵣ at the beginning of resonant interval can be calculated from input inductor current I_{L} during (1−D)T_{S} interval in FIG. 22b as:

Δvᵣ=½ I_{L}(1−D)/(Cᵣ f_{S}) (19)

Substitution of (15) and (16) into (19) results in

I_{P}=I_{L} (1−D)πfᵣ/f_{S} (20)

However, the capacitor resonant discharge current iₜ is limited to only a positive cycle of resonant current as diode rectifier CR₁ permits conduction in only one direction. This is because the series connection of transistor and current rectifier forms an effective two-quadrant composite switch, which acts as a voltage bi-directional switch.

### PFC Conversion Function

The equality of the DC conversion gains as a function of duty ratio D of the controlling switch S is a very important pre-requisite for a converter to operate as a Single-Stage AC-DC converter as postulated by the Single-Stage AC-DC Conversion Method earlier.

Another important factor is that both DC conversion gains are having a step-up DC gain characteristic which is another pre-requisite needed for the converter topology to qualify as an AC-DC converter topology. This therefore establishes that the present invention is indeed capable to operate as Single-Stage PFC AC-DC PFC converter.

Clearly this converter circuits meets all the prerequisites imposed by the single stage AC-DC PFC operation. In a clear departure from the previous attempts at bridgeless PFC conversion, all components, all three switches, input inductor, resonant inductor, and capacitor Cᵣ are 100% utilized as they take part in PFC operation for both positive as well as negative

### Hybrid Switching Method

The above relationship of equal DC conversion gain as a function of duty ratio for both positive and negative polarity input voltages, makes it possible to use the same converter topology with an AC input voltage directly and with the bridge rectifier being eliminated.

This was one of the important conditions imposed by the general Single-Stage Isolated Bridgeless PFC Conversion method. The other companion hybrid switching method is now emerging as well. ON-time switching interval for either polarity of the input voltage will result in resonant switching network for ON-time interval, and regular PWM network for OFF-time interval, thus justifying the name proposed of hybrid switching: consisting partly of square-wave switching (applicable to PWM inductor L for both switching intervals) and to resonant switching applicable to resonant inductor during only the ON-time interval. Hence hybrid switching is a combination of the square-wave (PWM) switching and resonant switching having the PWM inductor and resonant inductor.

### Control of the Input Current

The Power Factor Correction is based on controlling the average input current of the converters in FIG. 1a and FIG. 2a to become proportional and in phase to the input AC line voltage by use of the PFC IC controller. Thus instead of controlling output DC voltage to provide the output DC voltage regulation, the duty ratio modulation is used to control average input current to the switching converter. Therefore, the output DC voltage will be semi-regulated and will have a small ripple voltage provided an appropriate size output capacitor C is used.

The control of input current is then accomplished in two possible ways described below. The ON-time interval starts at zero level, which effectively constricts the resonant discharge interval to exactly one-half of the resonant period, that is

D_{R}T_{S}=Tᵣ/2 (21)

Tᵣ=1/fᵣ (22)

We have also introduced here a notion of the resonant duty ratio D_{R}. The resonant circuit is therefore formed by the loop consisting of two resonant components, Cᵣ and Lᵣ, switch S and respective current rectifiers connected in series as shown earlier hence limiting discharge current to only one direction. The discharge current starts at zero and ceases to conduct after half resonant interval when resonant current becomes zero again.

There are now two possible modes of operation to control the average input current:
1. Duty ratio modulation with constant switching frequency.
2. Constant ON-time and variable OFF time and therefore, variable switching frequency.

Let us first review regulation via classical duty ratio control.

### Duty Ratio Control

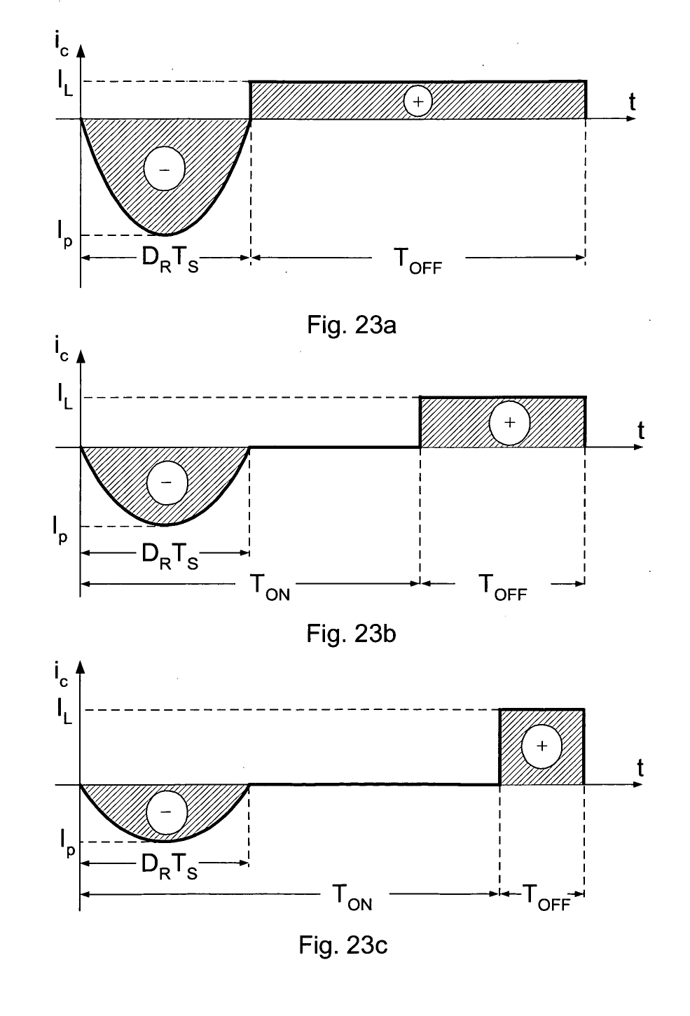

The three salient examples of duty ratio control are:
a) for low duty ratio D as shown in FIG. 23a.
b) medium duty ratio D as shown in FIG. 23b.
c) high duty ratio as shown in FIG. 23c.

In the first case in FIG. 23a, the resonant interval D_{R}T_{S} is just equal to ON-time DT_{S} interval. However, further increase of duty ratio will result in coasting interval shown by zero current level of capacitor Cᵣ as resonant discharge current was reduced to zero and rectifier CR₁ turned OF and stopped capacitor current at zero level.

If one wants to completely eliminate this capacitor Cᵣ current coasting zero interval, this could be done by using a variable OFF time control, hence variable switching frequency control as shown next.

### Constant ON-Time and Variable OFF-Time Control

For highest efficiency and best operational mode, zero coasting intervals described above should be eliminated. This is easily accomplished as follows. If the ON-time of the switch S is equal to half of a resonant period, then the resonant discharge current waveform will be exactly half a sine wave. The best mode of operation is then to keep the ON-time constant as per:

T_{ON}=DT_{S}=Tᵣ/2=constant (23)

so that duty ratio is proportional to switching frequency, or:

D=f_{S}/2fᵣ (24)

where ωᵣ and fᵣ are as defined earlier.

Thus, voltage regulation is obtained by use of the variable switching frequency fₛ. However, this results in corresponding duty ratio D as per (24). Note that all DC quantities, such as DC voltages on capacitors and DC currents of inductors are still represented as a function of duty ratio D only, as in the case of constant-switching frequency operation.

The waveforms of FIG. 24a, b, c show the constant ON-time (interval DT_{S}) displayed first to emphasize the variable OFF-time and variable switching frequency as well as the elimination of zero coasting intervals of constant switching frequency operation.

### Implementation of Switch S

In addition to two simple diode rectifiers the present invention, the single-stage PFC converter of FIG. 11a has one component, the controlling switch S whose implementation is critical to the overall efficiency.

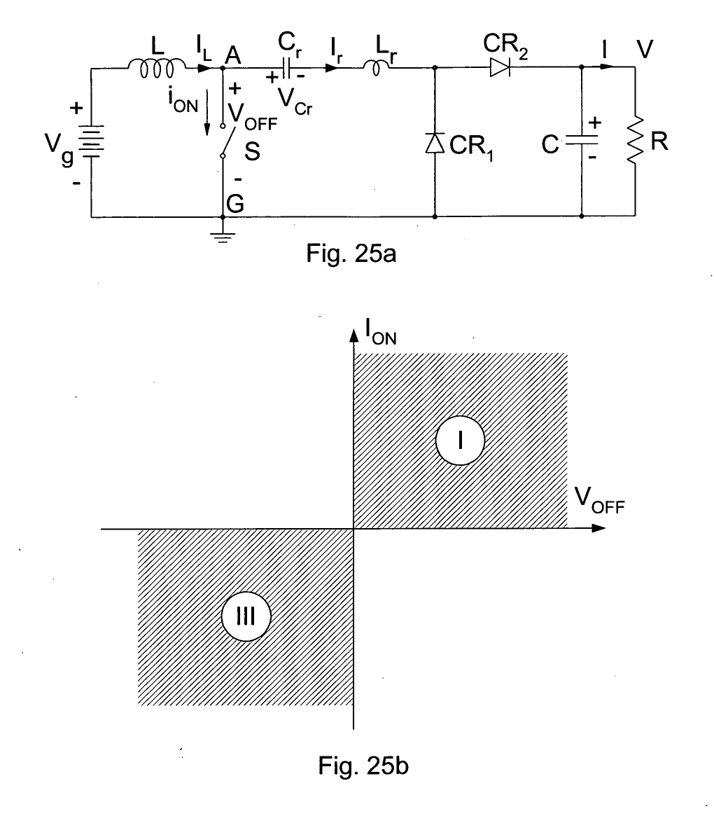

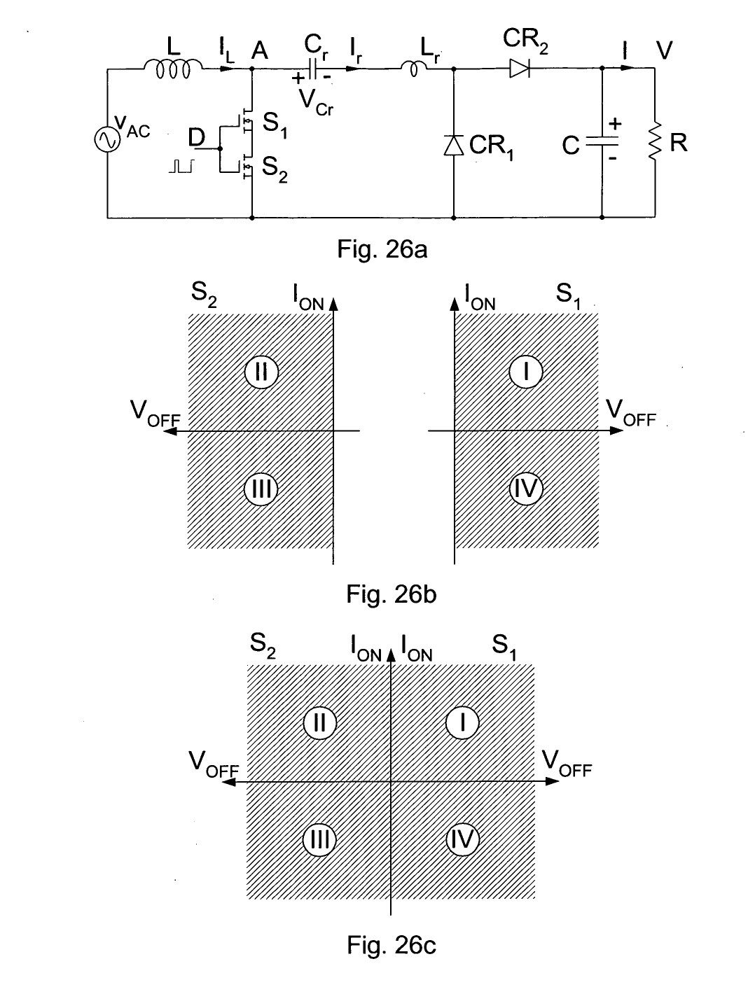

From the description of the converter operation for positive and negative output voltages, it is clear that this switch S has two-quadrant switching characteristic operating in the first and third quadrant as illustrated in definition of switch S in FIG. 4a and further emphasized in diagram of FIG. 25b. In other words, the switch S must block voltage of one polarity and conduct current in one direction, but also it should be able to block the voltage of opposite polarity and conduct the current in opposite direction. Unfortunately, at present such a switching characteristic is not available in a single semiconductor-switching device, so that its performance must be simulated by use of the two devices connected in cascade as shown by use of two re-channel MOSFET devices S₁ and S₂ connected back to back as in FIG. 206a and using a common floating drive circuitry. Shown in FIG. 20b and FIG. 20c are the respective two quadrant characteristics of each current bi-directional MOSFET switch. Therefore, their combination produces in effect a four-quadrant switch with characteristic as in FIG. 26c whereas the two-quadrant characteristic of FIG. 25b would be sufficient except such a single device does not exist at present time. It is expected that in the future a single two-quadrant switch having characteristic of FIG. 26b will be produced. This could reduced the conduction losses of the switch S by up to a factor of four, since two n-channel devices could be connected in parallel and not in series. Alternatively, for the same losses, the switch costs could be reduced significantly.

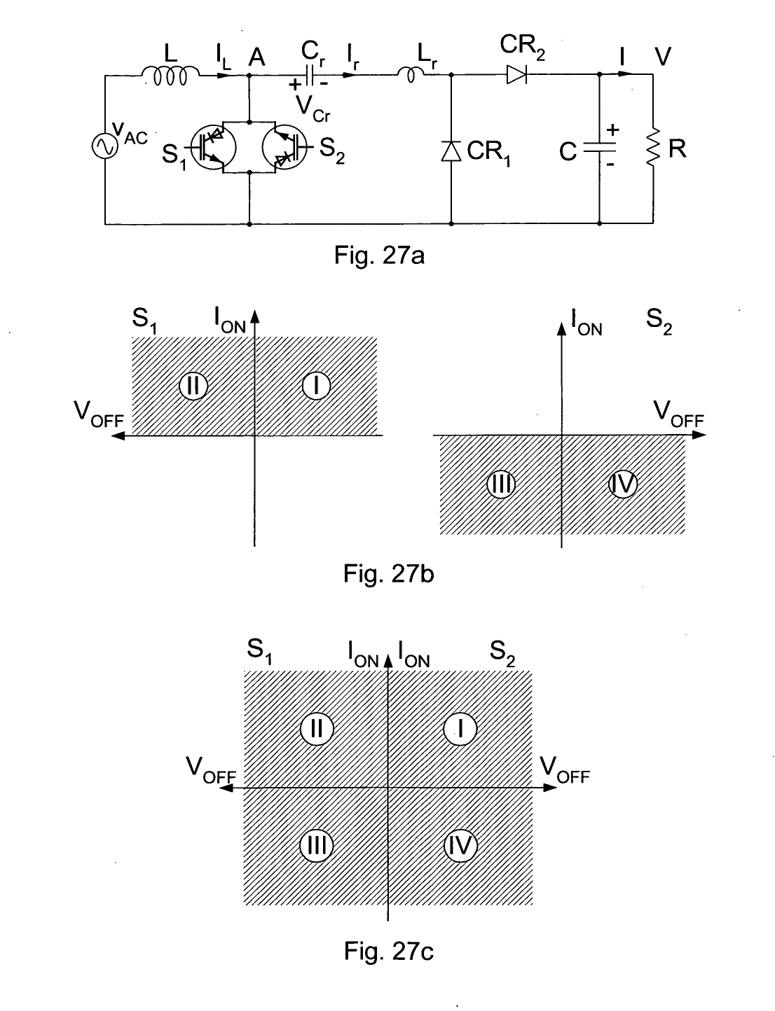

Another implementation that could also reduce conduction losses is to use two Reverse Blocking Isolated Gate Bipolar Transistor (RBIGBT) devices in parallel such as illustrated in FIG. 27a. Each of these devices is able to operate as a switch in one quadrant but also capable of blocking a full opposite voltage as illustrated by its individual quadrant characteristic of FIG. 27b. Therefore, two such switches operated in parallel would once again form an effective four quadrant switch of FIG. 27c.

### System Applications With Positive and Negative Outputs

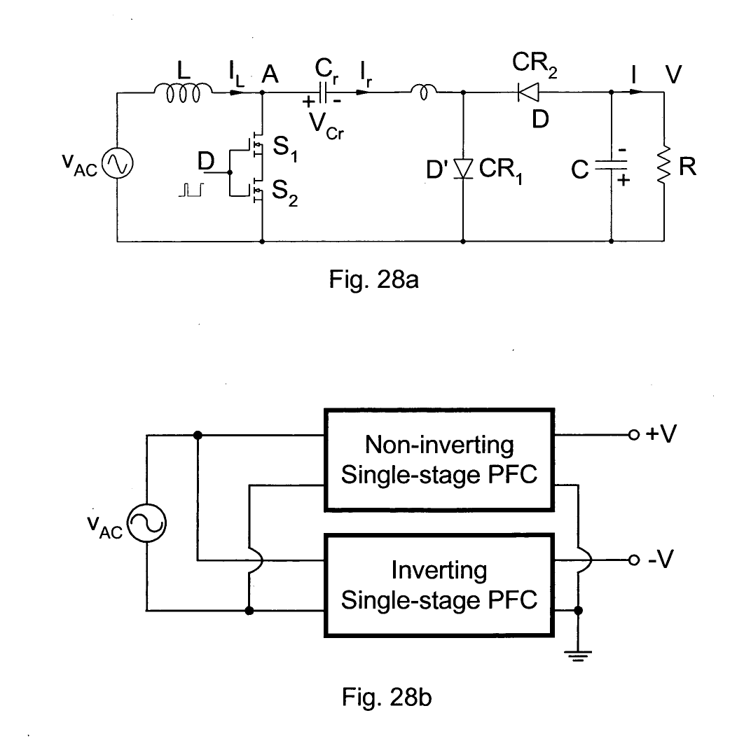

Shown in FIG. 28a is the extension having negative output voltage polarity, which is obtained by simply changing the directions of the output diodes. Note that such a simple negative output polarity extension is not available in conventional DC-DC converters.

This unique performance could be then used to generate from the AC line source two output DC voltages, positive and negative output polarity as illustrated in FIG. 28b by connecting two such converters in parallel on the input.

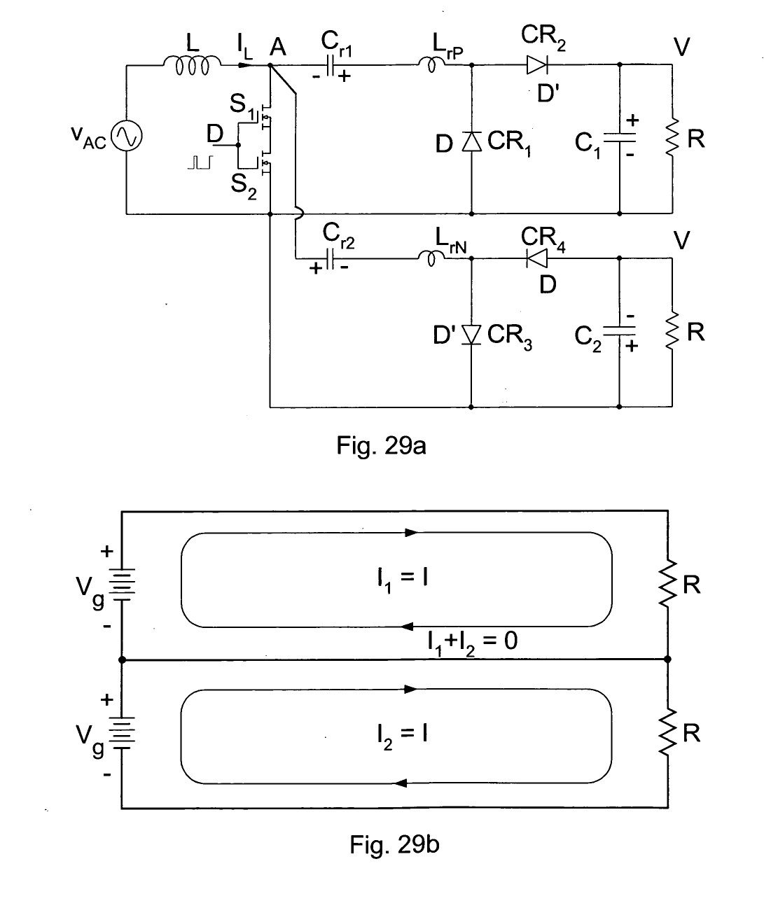

Further improvements could also be achieved by not using two inductor, and two switches on the front-end, but instead use a single inductor and the same switch S for both modules as shown in FIG. 29a.

The main advantage of generation of two DC voltages, positive and negative is that the DC distribution line can be made more efficient as shown in FIG. 29b in which the two return currents cancel in the neutral wire, so that double power could be transfer for the same wire capacity.

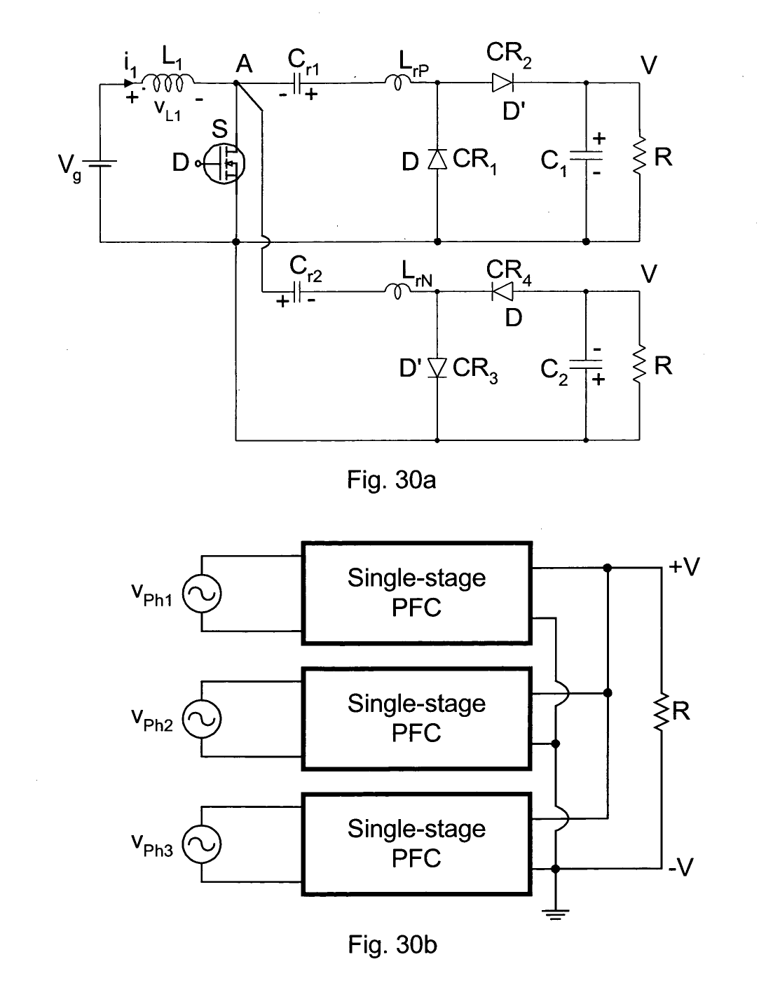

The above method could be used not only for AC-DC systems as above but also for DC-to-DC converter applications as shown in FIG. 30a. Note how the single inductor and single controlling switch is used to generate two output DC voltages of opposite polarities.

Finally by operating three such converters from three-phase line, such as illustrated in FIG. 30b, and into a common DC load, the large energy storage output capacitor on the output could be eliminated since the sum of the three phase output ripple currents is equal to zero, based on one of the fundamental properties of the three phase systems.

### Data Center Applications

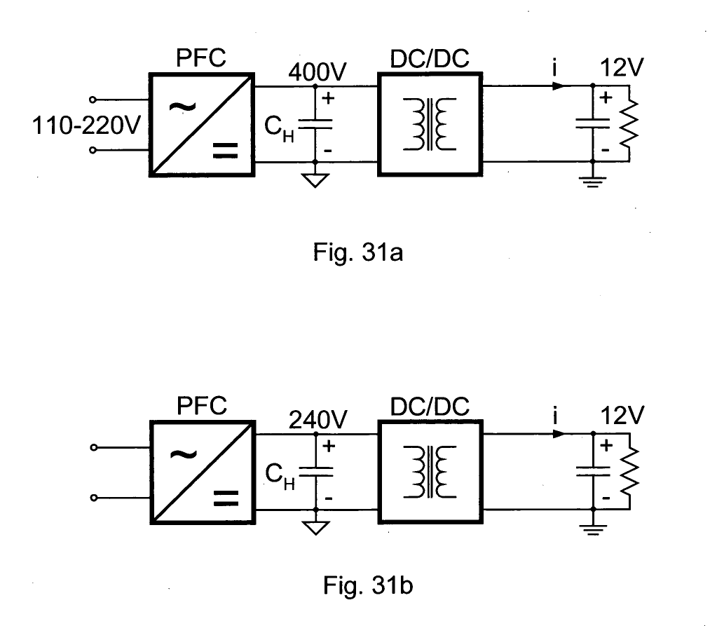

Data centers use the system configuration shown in FIG. 31a and FIG. 31b in which a non-isolated PFC converter is used to generate an intermediate storage at high DC voltage of 400V or 240V DC. For those applications, the non-isolated extensions of the Bridgeless PFC converter in FIG. 11a and FIG. 12a can be used.

### Voltage Stresses of the Switches

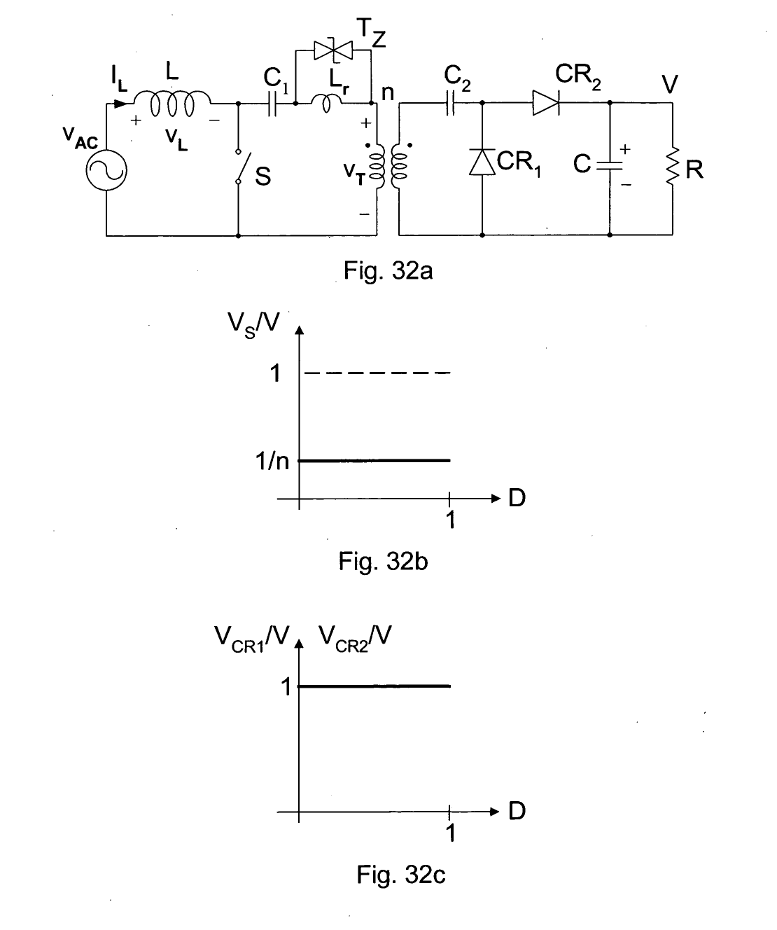

The low voltage stresses of the switches in the isolated extension of converter of FIG. 32a are shown graphically in FIG. 32b for primary switch S and in FIG. 32c for secondary side rectifiers. The secondary side rectifiers have the voltage stresses equal to the output DC voltage and therefore result in minimum possible voltage stress and maximum utilization of the output switches.

### Insertion of the Isolation Transformer

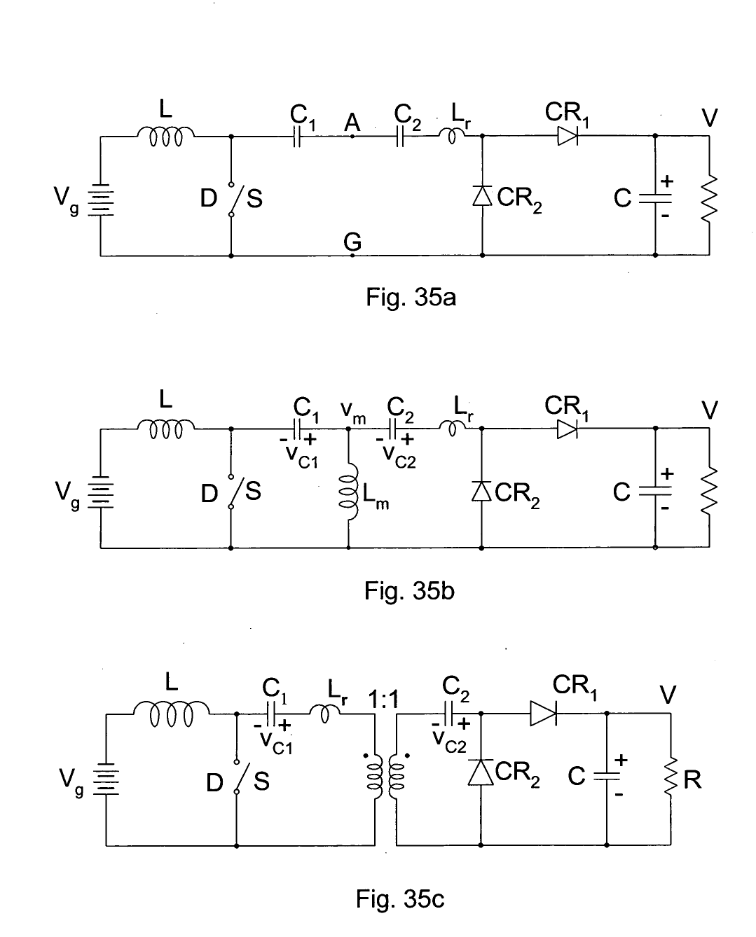

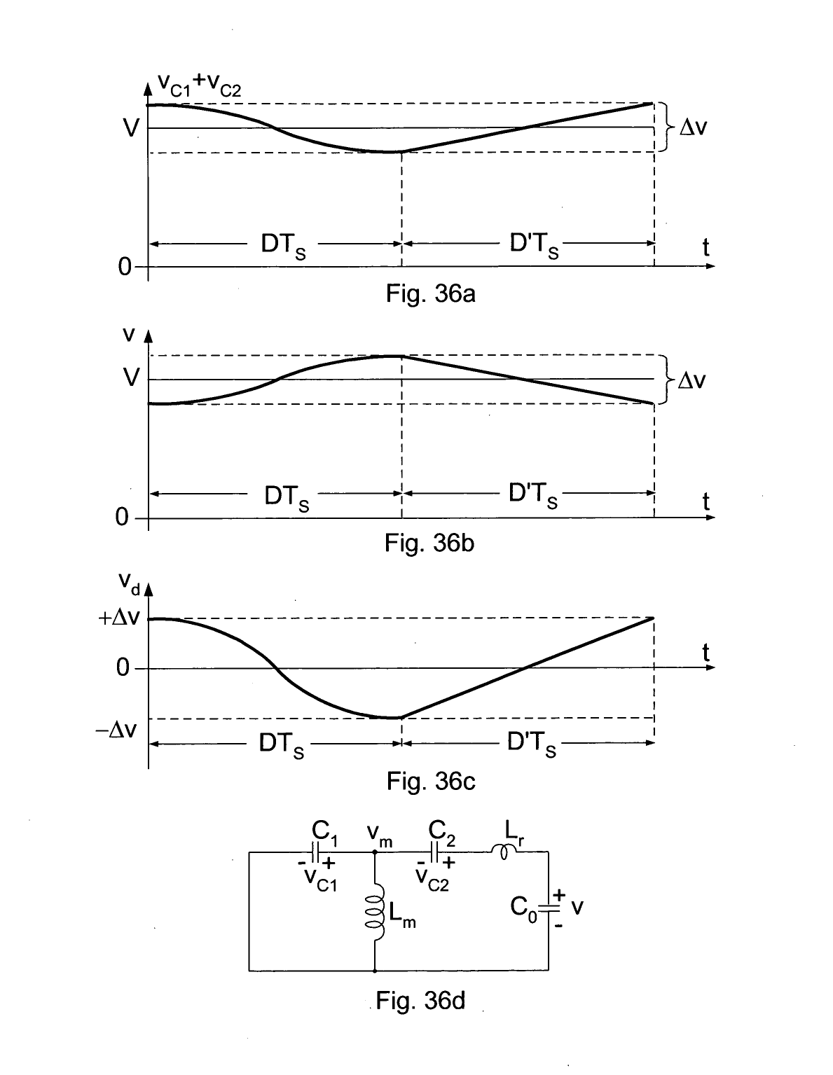

After we have analyzed in details the non-isolated extension, we now go back and reinsert the isolation transformer into the non-isolated converters to recreate the original isolated converter of FIG. 1a. This is accomplished by use of a equivalent circuit transformation displayed in FIGS. 33a-c, FIG. 34a-c, FIG. 35a-c, and FIG. 36a-d.

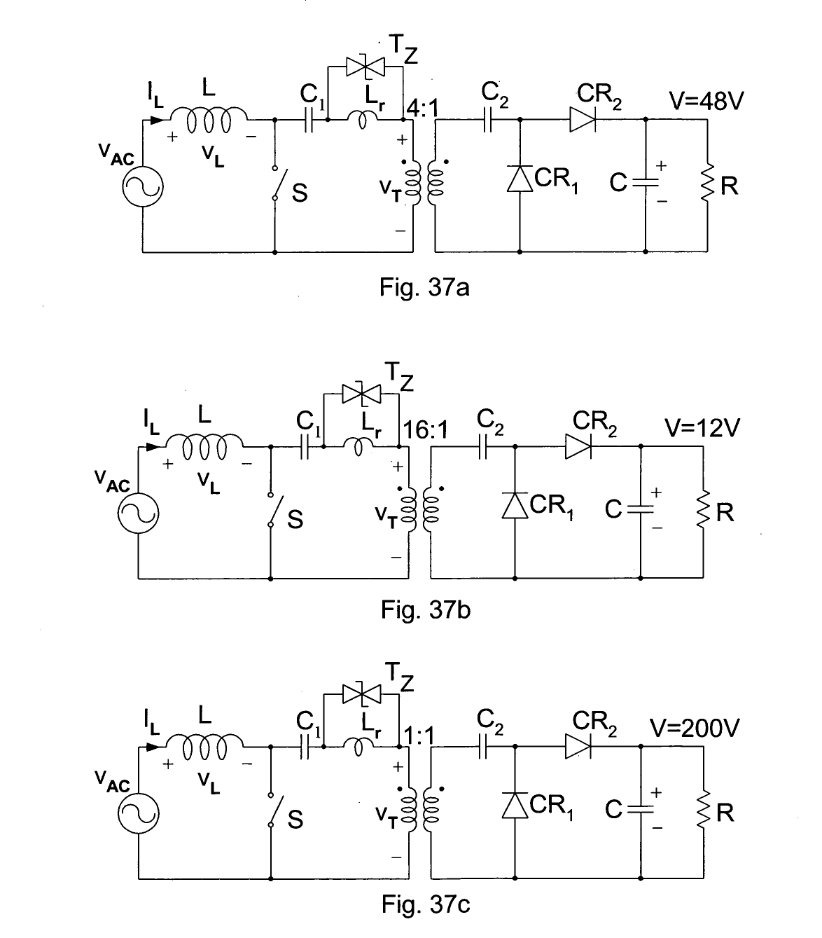

FIG. 37a-c demonstrate the use of the isolation transformer turns ratio to scale the output DC voltage to any value desired, such as for example, 48V Dc fo telecommunication applications, 12V DC for data centers and personal computers, and 200V for battery charging of the electric and hybrid cars for example.

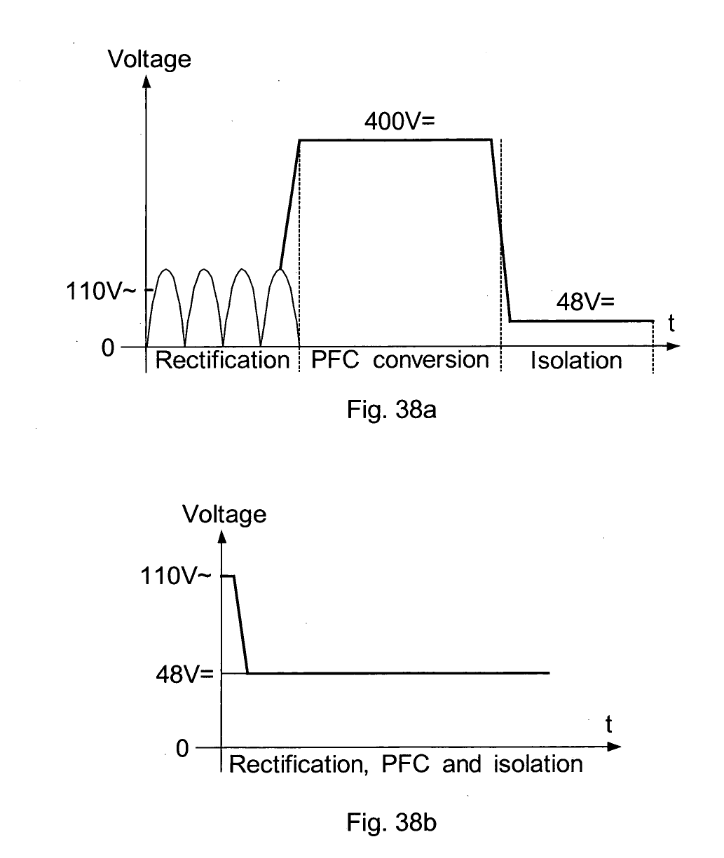

FIG. 38a illustrates how the non-isolated PFC converter of FIG. 11a is used to step-up the voltage to intermediate high DC voltage and then via separate isolated DC-DC converter as per diagram of FIG. 31a. However, the converters of FIG. 1a and FIG. 2a can generate the low DC voltage output such as 48V or 12V directly in a single-stage power processing without using an intermediate high DC voltage bus as illustrated in FIG. 38b.

### Integrated Magnetics Embodiment

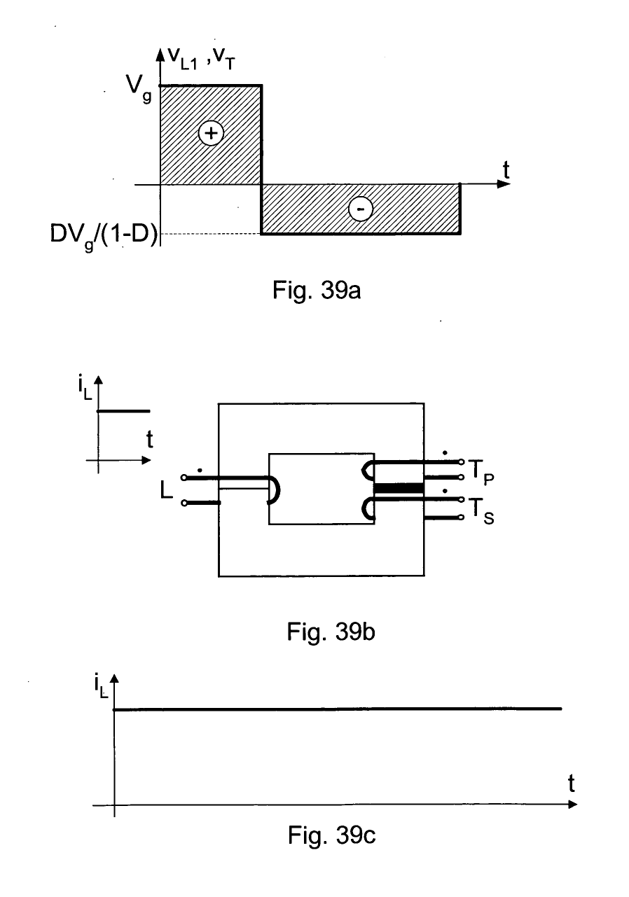

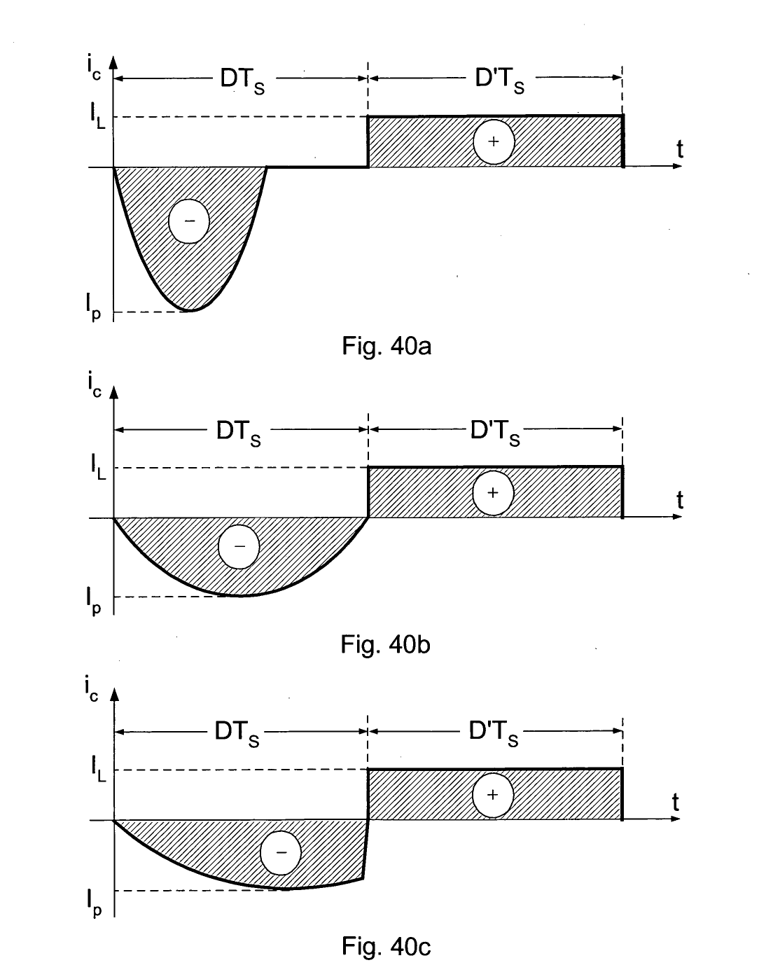

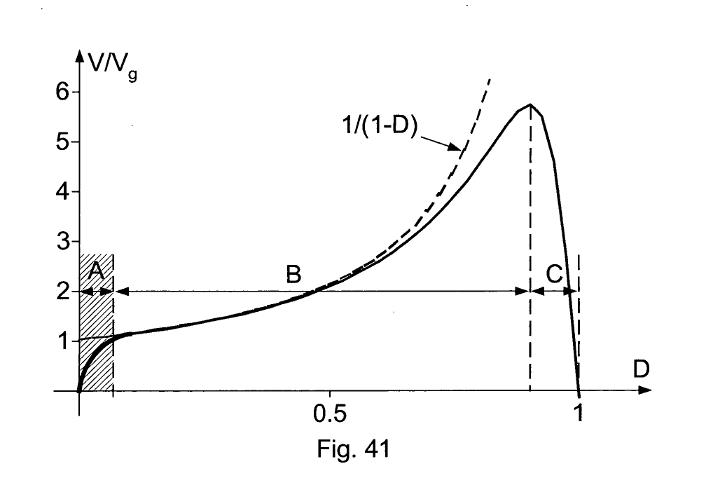

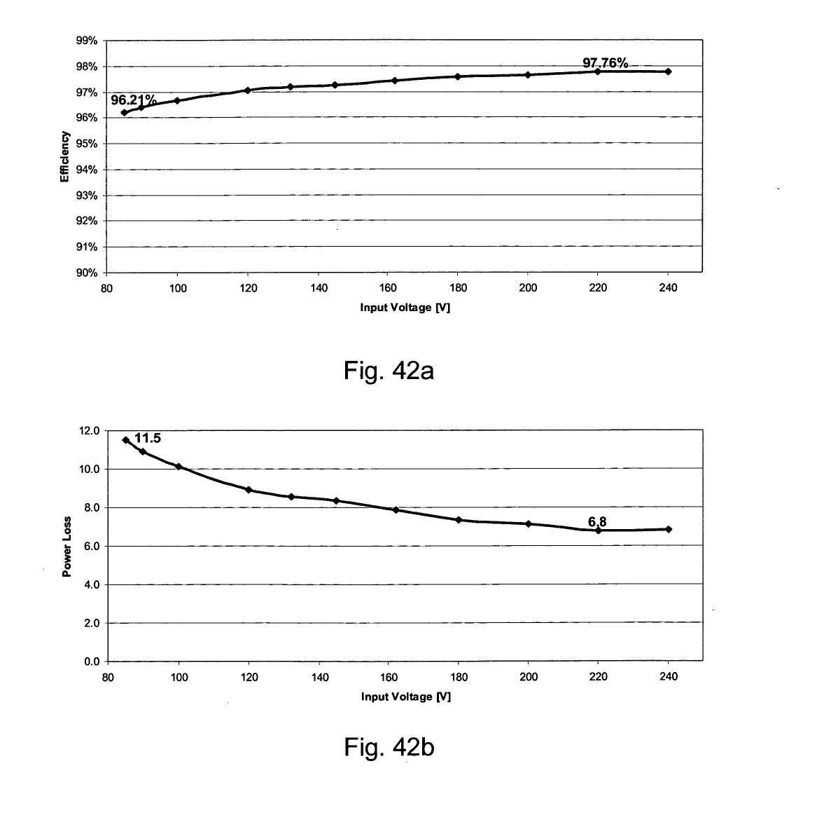

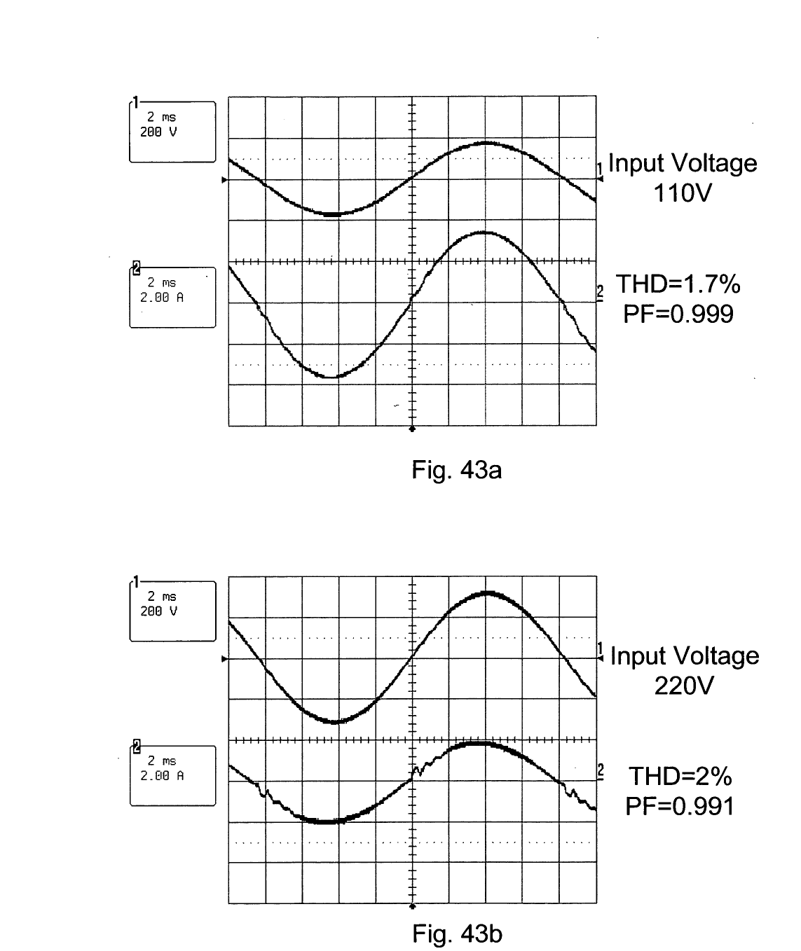

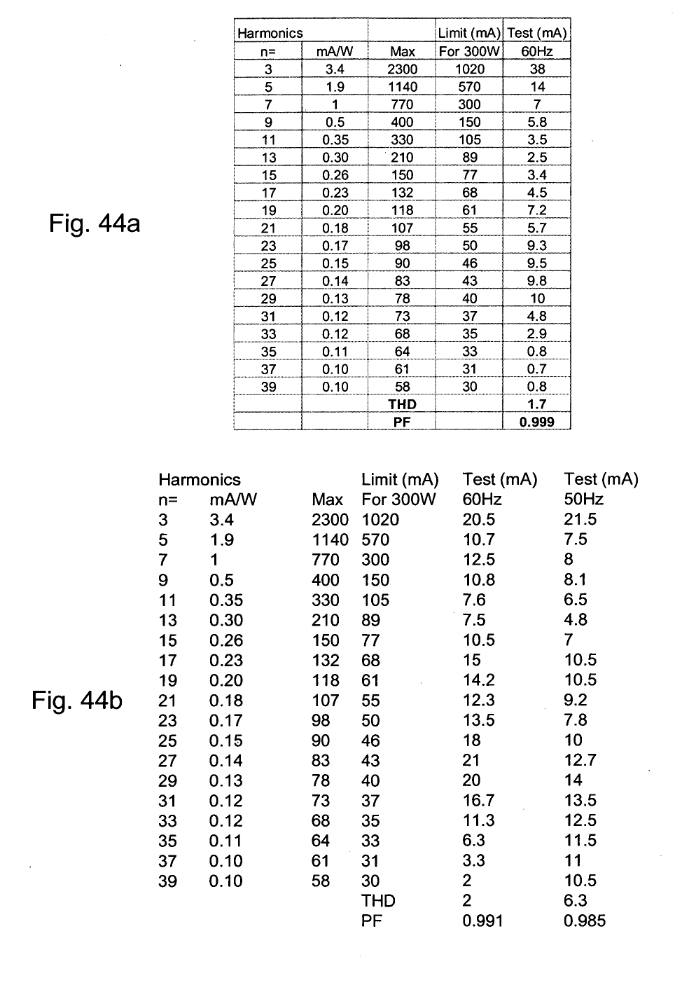

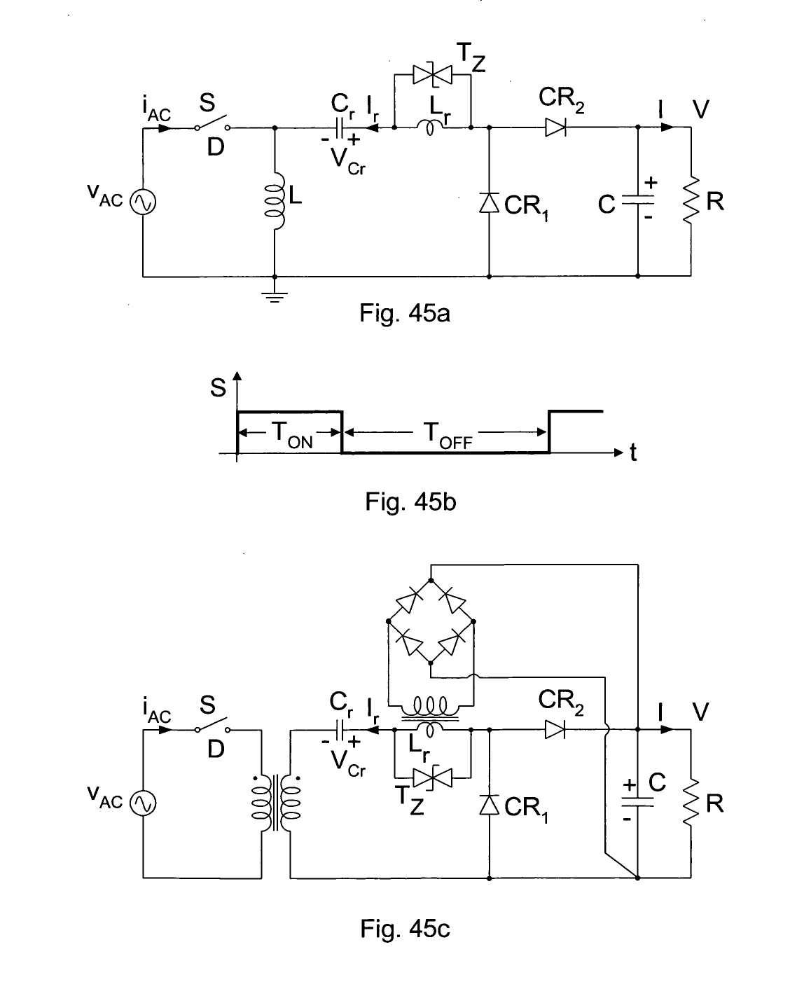

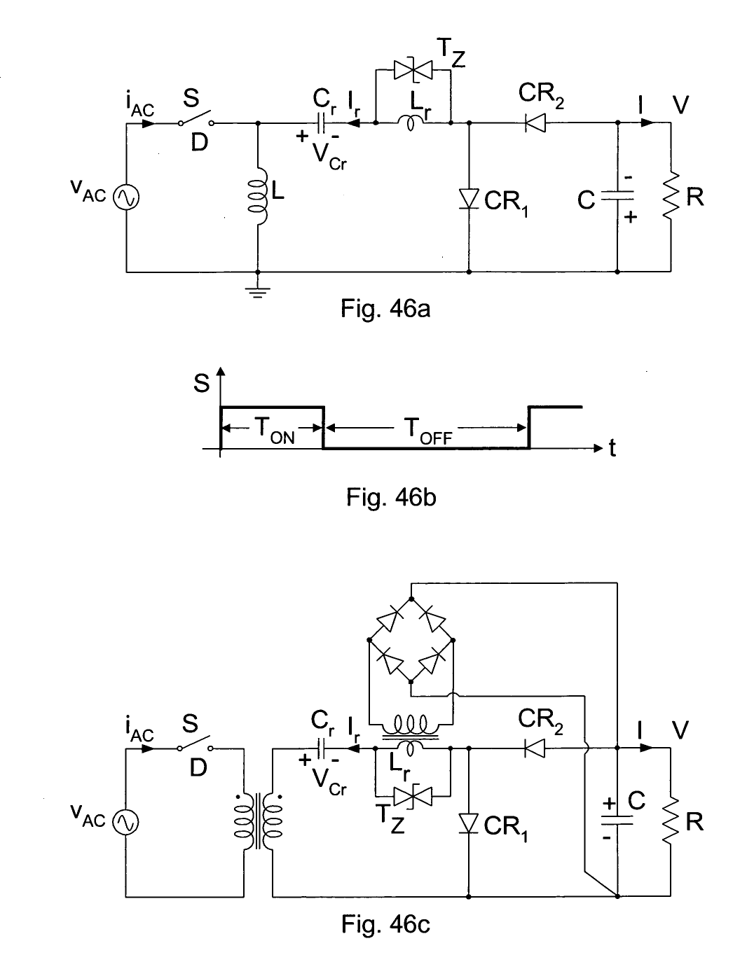

The voltage waveforms of the inductor L and transformer T in the converter of FIG. 1a are identical as seen in FIG. 39a. This then makes it possible to integrate the inductor and transformer on the common core to result in the integrated magnetics (IM) structure of FIG. 39b which in turn, by judicious design of the magnetics, will result in the removal of the input ripple current, or actually its shift into the transformer windings so that the high frequency ripple current is eliminated and the need for separate high frequency filter is also eliminated. Yet the smooth noise free input current of FIG. 1c is obtained.

Shown in FIG. 40a-c is the case of another possible modulation strategy, that is constant OFF-time and variable ON time modulation.

### Converter Start-up

The DC gain characteristic of (4) suggests that the isolated converter would have the start-up problem as the DC gain characteristic is always greater than 1. Yet at start-up the output DC voltage is zero (discharged output capacitor) which would tend to indicate that the converter would never be able to start-up as it does not have the Dc conversion gain extending to zero at low duty ratios. However, this is not correct as this converter does have a special mode of operation at low duty ratios.

Shown in FIG. 41a with thin dotted lines is the ideal DC conversion gain characteristic given by (4). The actual measured DC conversion characteristic shown in heavy lines, reveals the existence of the shaded region at very low duty ratios during which the DC conversion gain drops to zero. Therefore, effectively, the actual DC conversion gain is that of a step-down/step-up type. Thus, the output DC voltage eve in the isolated converter case can be started smoothly from zero DC output voltage and brought by duty ratio increase into a step-up DC conversion region for the operation as a isolated PFC controller.

### Experimental Verifications

The Single-Stage AC-DC Converter with Isolation and Power factor Correction (PFC) performance features is verified by on an experimental 400 W prototype, which converts 110V AC line voltage and 220V AC line voltage into a 400V isolated output voltage with very high efficiency over the wide range. FIG. 42a shows the efficiency measurements at a 300 W level over the wide input AC voltage range from 85V AC to 240V AC and FIG. 42b shows the corresponding FIG. 43a shows the line voltage (top trace) and AC line current (bottom trace). The Power factor was measured at 300 W load to be 0.999. loss measurements.

Very high efficiency of over 97% was measured over the wide input AC voltage. In particular note the very high efficiency at the low AC line voltage of 85VAC as shown in FIG. 42a while the low total losses are shown in FIG. 42bb. This clearly indicates the absence of the bridge rectifier on the front. The prior-art PFC converters have a significant efficiency drop at the low 85V AC line due to the two-diode voltage drops. Furthermore, they do not have the isolation built in as is the case here.

FIG. 43a shows the line voltage (top trace) and AC line current (bottom trace) at 110V 60 Hz input voltage . The Power factor was measured at 300 W load to be 0.999 and THD 1.7%.

FIG. 43b shows the line voltage (top trace) and AC line current (bottom trace) at 220V AC and 60 Hz. The Power factor was measured at 300 W load to be 0.991 and THD 2%.

The measurement of harmonics currents is displayed in the Tables shown in FIG. 44a and FIG. 44b respectively,

### OTHER EMBODIMENTS

Following the Single-stage method outlined in FIG. 3b other embodiments with a different converter topologies but can be synthesized such as those in FIG. 45a, FIG. 45c and FIG. 46a and FIG. 46b.

### CONCLUSION

The Single-Stage AC-DC converter with isolation and PFC is provided which eliminates the full-bridge rectifier altogether. Therefore, the present invention results in several basic advantages PFC converter:
1. Higher efficiency due to Single-stage operation vs. three-stage operation of conventional converters.
2. Reduction of the cost due to elimination of the bridge rectifier and elimination of the separate isolated DC-DC converter.
3. Reduction of the size due to the elimination of bridge and additional Isolated DC-DC converter.
4. Full utilization of all the components for both positive and negative part of the input AC cycle as there are no idle components in either cycle.
5. Single magnetics, low cost implementation.
6. Low voltage stresses on all switches.
7. DC voltage step-up function.

### REFERENCES

1. Slobodan Cuk, “Modelling, Analysis and Design of Switching Converters”, PhD thesis, November 1976, California Institute of Technology, Pasadena, Calif., USA.
2. Dragan Maksimovic, “Synthesis of PWM and Quasi-Resonant DC-to-DC Power Converters”, PhD thesis, Jan. 12, 1989, California Institute of Technology, Pasadena, Calif., USA;
3. Vatche Vorperian, “Resonant Converters”, PhD thesis, California Institute of technology, Pasdena, Calif.;
4. Slobodan Cuk, R. D. Middlebrook, “Advances in Switched-Mode Power Conversion”, Vol. I, II, and III, TESLAco 1981 and 1983.

What is claimed is:

1. A converter for providing power from an AC voltage source connected between an input terminal and a common input terminal to a DC load connected between an output terminal and a common output terminal, said converter comprising:
an input inductor winding and an isolation transformer with primary and secondary windings placed on a common magnetic core to form an Integrated Magnetics, and each winding having one dot-marked end and an other unmarked end;
said input inductor winding connected at said unmarked end thereof to said input terminal;
said primary winding of said isolation transformer connected at said unmarked end thereof to said common input terminal;
said secondary winding of said isolation transformer connected at said unmarked end thereof to said common output terminal;
an input switch with one end connected to said common input terminal and another end connected to said dot-marked end of said input inductor;
a first capacitor with one end connected to said dot-marked end of said primary winding and another end connected to said dot-marked end of said input inductor;
a second capacitor with one end connected to said dot-marked end of said secondary winding;
a resonant inductor winding connected at one end thereof to another end of said second capacitor;
a first diode switch with an anode end connected to said common output terminal and a cathode end connected to another end of said resonant inductor winding;
a second diode switch with an anode end connected to said cathode end of said first diode switch and a cathode end of said second diode switch connected to said output terminal;
a transient voltage suppression device (transorb) connected in parallel with said resonant inductor;
switching means for keeping said input switch ON for a duration of time interval DT_{S} and keeping it OFF for a complementary duty ratio interval (1−D)T_{S}, wherein D is a duty ratio of said input switch and T_{S} is a switching period;
wherein said input switch is a controllable semiconductor voltage bi-directional switching device, capable of conducting the current in either direction while in an ON-state, and sustaining voltage of either polarity, while in an OFF-state;
wherein said first diode switch and said second diode switch are semiconductor current rectifier switching devices controlled by both said ON-state and said OFF-state of said input switch and polarity of a voltage from said AC voltage source;
wherein said first diode switch and said second diode switch either conduct or block the current depending on both said states of said input switch and polarity of said voltage from said AC voltage source so that a DC voltage is provided to said DC load.
wherein depending on both said states of said input switch and polarity of said voltage from said AC voltage source said resonant inductor and said second capacitor form resonant circuits either with said first diode switch or with said second diode switch, each conducting a half sine-wave resonant current during one half of a resonant period;
wherein leakage inductance between said input inductor winding and said isolation transformer windings provides substantially zero-ripple current in said input inductor winding;
wherein said switching means use both a voltage signal and a current signal from said AC voltage source to control said ON-state and said OFF-state of said input switch in a such a way to force a current from said AC voltage source to be proportional and in phase with said voltage from said AC voltage source;
wherein turns ratio of said secondary winding to said primary winding of said isolation transformer provides additional control of voltage conversion ratio of said converter, and
wherein said isolation transformer provides galvanic isolation between said AC voltage source and said DC load.

2. A converter for providing power from an AC voltage source connected between an input terminal and a common input terminal to a DC load connected between an output terminal and a common output terminal, said converter comprising:
an isolation transformer with a primary winding and a secondary winding, each said winding having one dot-marked end and an other unmarked end;
said primary winding of said isolation transformer connected at said unmarked end thereof to said common input terminal;
said secondary winding of said isolation transformer connected at said unmarked end thereof to said common output terminal;
an input switch with one end connected to said input terminal and another end connected to said dot-marked end of said primary winding of said isolation transformer;
a capacitor with one end connected to said dot-marked end of said secondary winding of said isolation transformer;
a resonant inductor winding connected at one end thereof to another end of said capacitor;
a first diode switch with an anode end connected to said common output terminal and a cathode end connected to another end of said resonant inductor winding;
a second diode switch with an anode end connected to said cathode end of said first diode switch and a cathode end of said second diode switch connected to said output terminal;
a transient voltage suppression device (transorb) connected in parallel with said resonant inductor;
switching means for keeping said input switch ON for a duration of time interval DT_{S} and keeping it OFF for a complementary duty ratio interval (1−D)T_{S}, wherein D is a duty ratio of said input switch and T_{S} is a switching period;
wherein said input switch is a controllable semiconductor voltage bi-directional switching device, capable of conducting the current in either direction while in an ON-state, and sustaining voltage of either polarity, while in an OFF-state;
wherein said first diode switch and said second diode switch are semiconductor current rectifier switching devices controlled by both said ON-state and said OFF-state of said input switch and polarity of a voltage from said AC voltage source;
wherein said first diode switch and said second diode switch either conduct or block the current depending on both said states of said input switch and polarity of said voltage from said AC voltage source so that a DC voltage is provided to said DC load.
wherein depending on both said states of said input switch and polarity of said voltage from said AC voltage source said resonant inductor and said capacitor form resonant circuits either with said first diode switch or with said second diode switch, each conducting a half sine-wave resonant current during one half of a resonant period;
wherein said switching means use both a voltage signal and a current signal from said AC voltage source to control said ON-state and said OFF-state of said input switch in a such a way to force a current from said AC voltage source to be proportional and in phase with said voltage from said AC voltage source;
wherein turns ratio of said secondary winding to said primary winding of said isolation transformer provides additional control of voltage conversion ratio of said converter, and
wherein said isolation transformer provides galvanic isolation between said AC voltage source and said DC load.

3. A method for hybrid switched-mode AC-to-DC power conversion comprising:
providing an input switch being voltage bi-directional and current bi-directional controllable switch having an ON-time interval DT_{S} and an OFF-time interval (1−D)T_{S} within a switching time period T_{S} where D is a duty ratio of said input switch;
providing two output switches being current rectifiers respectively conducting and blocking currents in response to operating states of said input switch and polarity of said input AC source;
providing an PWM inductor operating and being flux-balanced over the entire said switching time period T_{S};
providing a resonant inductor operating and being flux-balanced during a part of said switching time interval T_{S};
providing a resonant capacitor, during either positive or negative polarity of said AC source, being charged and discharged in a resonant fashion through said resonant inductor and said two output switches respectively;
controlling said ON-time and said OFF-time intervals of said input switch in response to current and voltage signals from said AC source forcing current and voltage waveforms from said AC source to be proportional and in phase;
providing PWM voltage and current waveforms on said PWM inductor during entire said switching time interval T_{S};
providing resonant voltage and current waveforms on said resonant inductor during said OFF-time interval;
initiating a PWM operation mode by turning one of said two controllable three-terminal switches ON while another controllable three-terminal switch is OFF;
initiating a resonant operation mode by turning said one controllable three-terminal switch OFF and turning said another controllable three-terminal switch ON;
providing a resonant circuit comprising said resonant capacitor and said resonant inductor by keeping said another controllable three-terminal switch ON and having said two-terminal switch ON during said OFF-time interval;
providing said resonant inductor and said resonant capacitor form a resonant circuit during said OFF-time interval and define a constant resonant frequency and corresponding constant resonant period;
controlling said OFF-time interval to be equal to one half of said constant resonant period.

4. A converter as defined in claim 1, in which isolation transformer is eliminated to result in a non-isolated extension of the converter.

5. A converter as defined in claim 2, in which isolation transformer is eliminated to result in a non-isolated extension of the converter.

6. A converter as defined in claim 3, in which isolation transformer is eliminated to result in a non-isolated extension of the converter.

7. A converter as defined in claim 1,
wherein said input switch is a composite switch consisting of two n-channel MOSFETs connected back to back with a common floating gate drive.

8. A converter as defined in claim 1,
wherein said input switch is a composite e switch consisting of two RBIGBT transistors connected in parallel, with one operating for positive input voltage and the other for negative input voltage.

9. A converter as defined in claim 2,
wherein said input switch is a composite switch consisting of two n-channel MOSFETs connected back to back with a common floating gate drive.

10. A converter as defined in claim 2,
wherein said input switch is a composite e switch consisting of two RBIGBT transistors connected in parallel, with one operating for positive input voltage and the other for negative input voltage.
